(19) United States
(12) Patent Application Publication
(10) Pub. No.: US 2026/0132308 A1
(43) Pub. Date: May 14, 2026

(54) Coating Composition and Coated Label

(71) Applicant: Brady Worldwide, Inc., Milwaukee, WI (US)

(72) Inventors: Brian J. Fraleigh, Shorewood, WI (US); Erin Eggert, Mequon, WI (US); Tapan K. Debroy, Menomonee Falls, WI (US)

(21) Appl. No.: 19/386,722

(22) Filed: Nov. 12, 2025

Related U.S. Application Data
(60) Provisional application No. 63/719,378, filed on Nov. 12, 2024.

(51) Int. Cl. C09D 175/06; C09D 7/20; C09D 7/61; C09D 7/80; C09J 5/00; C09J 7/38

(52) U.S. Cl. CPC C09D 175/06; C09D 7/20; C09D 7/61; C09D 7/80; C09J 5/00; C09J 7/385; C09J 2203/334; C09J 2301/302; C09J 2301/40; C09J 2301/50; C09J 2400/10; C09J 2467/006

(57) ABSTRACT

The present disclosure provides a coating composition containing (A) a resin having a hydroxyl number of at least 2; (B) a pigment; (C) a crosslinking agent including an isocyanate prepolymer; and (D) a solvent. The present disclosure also provides a method of forming a coating composition including: (A) mixing a resin having a hydroxyl number of at least 2, a pigment, a solvent, and a dispersant to form a composition; and (B) mixing a crosslinking agent including an isocyanate prepolymer with the composition under reactive conditions to form a coating composition.

### BACKGROUND

The present disclosure is directed to coating compositions for labels.

Labels, and specifically printed labels, in the food and beverage industry are subjected to periodic cleaning protocols that include high temperature and high pressure power washing, along with exposure to acidic, basic, and other types of cleaners. The labels, and the printing thereon, must remain intact and legible following such washing and exposure. Labels that are printable with vibrant colors that maintain their vibrancy under harsh conditions, such as high pressure washes and chemical exposure, are desired for use in food and beverage industry settings. Labels printed with vibrant colors are easier to read and are more visually attractive. Labels that are easier to read are safer to use in food and beverage industry settings, where the printing may include vital safety information. If the label's vibrancy fades after being exposed to harsh conditions, it can result in a label that is difficult or impossible to read, which can be dangerous.

Methods exist for creating highly-durable signage (e.g. porcelain enamel coatings on steel) that can survive these protocols. However, many processes for creating durable signage are not easy or economical to customize for the end user, and cannot be created (or printed) on demand.

A customizable print-on-demand solution is available that is based on heat transfer (THT) printing onto a label stock. While this offers the advantages of customizability and rapid use, it is limited to only one color for on-demand printing (e.g. black) and is not receptive to aqueous inkjet inks. For some food and beverage facility operators, the ability to generate custom, print-on-demand, and highly durable signage in full color is desirable.

Inkjet-receptive coatings have been used to create full-color images, signage, and labels on demand. Labels that accept solvent and/or UV inks would be the likeliest candidates to withstand food and beverage industry cleaning protocols. However, printers that use solvent and UV inks are expensive compared to aqueous inkjet printers, and often generate harmful fumes that are incompatible with an office environment.

The formulation of aqueous ink-receptive coatings in the prior art has been accomplished in one of several ways: a) the use of water-soluble swellable polymers, b) the combination of water-based emulsion polymers and microporous pigments, c) the use of cations or polycations, and d) combinations of (a), (b) and (c). Swellable polymers readily absorb the water carrier fluid in the ink while fixing the pigment in place, but they are easily removed by lengthy exposure to hot water. Pigmented emulsion coatings provide the same function, with absorptivity being provided by the porosity of pigment particles rather than by swelling of the polymer matrix; however, they do not adhere sufficiently well to polymeric substrates to endure power washing. Cationic materials tend to increase the vibrancy and fix the ink pigments in place while the carrier fluid dries, but limited adhesion to a substrate is a result of the complex mechanisms by which emulsion polymers coalesce into a film during the drying process. Thus, none of the above approaches result in a coating that is sufficiently durable to resist food and beverage industry cleaning protocols.

Solvent-based coatings have long been used for general industrial use (e.g. automotive, anti-corrosion, and can and coil applications). Solvent-based polymer resins are easily engineered with active sites on the polymer backbone that can be chemically crosslinked using appropriate quantities of a co-reactant to form highly durable and water-resistant coatings with good adhesion to substrates, polymeric or otherwise. However, the use of solvent-based systems to formulate inkjet-receptive coatings in the prior art is limited, likely due to a) the few number of market players capable of working safely with solvent-based systems, and b) the difficulty of formulating solvent-based coatings with sufficient absorptivity to function with aqueous inkjet inks.

A need exists for a hard, tough, and flexible label coating that accepts aqueous inkjet inks and has sufficient durability to survive food and beverage industry cleaning protocols when cast onto a polymeric substrate. The present disclosure solves the problem of creating economical, full-color, extremely durable label for immediate use. The present disclosure is suitable for food and beverage facility operators, as well as any entity that frequently needs to create durable full-color signage on demand.

The art recognizes a need for labels that can be printed with a machine printer, such as an inkjet printer, to form vibrant graphics on the label that are easy to read and do not diminish in vibrancy after being exposed to harsh wash conditions. The art also recognizes the need for labels that can be printed with a machine printer, such as an inkjet printer, to form graphics on the label that do not become illegible or come off after being exposed to chemicals (such as MEK), or after being exposed to abrasive conditions (such as a kitchen scrubby).

### SUMMARY

The present disclosure provides a coating composition. In an embodiment, the coating composition contains (A) a resin having a hydroxyl number of at least 2; (B) a pigment; (C) a crosslinking agent comprising an isocyanate prepolymer; and (D) a solvent.

The present disclosure also provides a method of forming a coating composition including: (A) mixing a resin having a hydroxyl number of at least 2, a pigment, a solvent, and a dispersant to form a composition; and (B) mixing a crosslinking agent comprising an isocyanate prepolymer with the composition under reactive conditions to form a coating composition.

The present disclosure also provides a coated label. The coated label includes (A) a polymeric substrate having a top surface and an opposing bottom surface; (B) an adhesive layer in contact with the bottom surface of the polymeric substrate; and (C) a coating layer in contact with the top surface of the polymeric substrate, the coating layer formed from a coating composition containing (i) a resin having a hydroxyl number of at least 2; (ii) a pigment; (iii) a crosslinking agent comprising an isocyanate prepolymer; and (iv) a solvent.

The present disclosure also provides a method of forming a coated label. The method includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to a top surface of a polymeric substrate to form a coated substrate; (D) drying the coated substrate to form a dried coated substrate; (E) exposing the dried coated substrate to a mordant composition including a second solvent, a mordant, and a surfactant to form a mordant-treated coated substrate; (F) drying the mordant-treated coated substrate to form a dried mordant-treated coated substrate; and (G) applying an adhesive layer to a bottom surface of the polymeric substrate of the dried mordant-treated coated substrate to form a coated label.

### BRIEF DESCRIPTION OF THE DRAWINGS

FIG. 1 is the template that was printed on each example and comparative example.

FIG. 2 is a schematic of a coated label in accordance with an embodiment of the present disclosure.

FIG. 3 is a schematic of a coated label in accordance with another embodiment of the present disclosure.

FIG. 4 is a perspective view of a coated label in accordance with an embodiment of the present disclosure.

FIG. 5 is a schematic of a coated label in accordance with another embodiment of the present disclosure.

### DEFINITIONS AND TEST METHODS

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The terms “comprising,” “including,” “having,” and their derivatives, are not intended to exclude the presence of any additional component, step, or procedure, whether or not the same is specifically disclosed. In order to avoid any doubt, all articles claimed through use of the term “comprising” may include any additional component, feature, or element, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa. As used herein, “a,” “an,” “the,” “at least one,” and “one or more” are used interchangeably.

The term “composition” refers to a mixture of materials which comprise the composition, as well as reaction products and decomposition products formed from the materials of the composition.

An “acrylic polyol resin” is an acrylic resin that includes hydroxy monomers. An acrylic resin is a thermoplastic resin formed by polymerizing the esters of amides of acrylic or methacrylic acid.

“Contact” refers to direct contact and indirect contact.

“Direct contact” means a layer configuration whereby a first layer is located immediately adjacent to a second layer and no intervening layers or no intervening structures are present between the first layer and the second layer.

The term, “ethylene-based polymer,” as used herein, refers to a polymer that comprises, in polymerized form, at least 50 wt % or a majority amount of ethylene monomer (based on the weight of the polymer), and optionally may comprise one or more comonomers. In one embodiment, the ethylene-based polymer comprises a majority amount of ethylene monomer (based on the weight of the ethylene-based polymer), and optionally may comprise one or more comonomers.

“Facial surface”, “planar surface”, “top surface”, “bottom surface” and the like are used in distinction to “edge surface”. If rectangular in shape or configuration, an article, e.g., a layer or film, will comprise two opposing facial surfaces joined by four edge surfaces (two opposing pairs of edge surfaces, each pair intersecting the other pair at right angles). If circular in configuration, then the article will comprise two opposing facial surfaces joined by one continuous edge surface.

The term “functional group,” as used herein, refers to a chemical group comprising at least one heteroatom (e.g., O, N, Si, Cl). A functional group may additionally contain unsaturation. Exemplary functional groups include, but are not limited to, organic anhydrides, organic amines, organic acids, organic amides, organic esters, and organic alcohols.

The term “hydrocarbon,” as used herein, refers to a chemical group containing only hydrogen atoms and carbon atoms.

“Indirect contact” means a layer configuration whereby a first layer is located adjacent to a second layer and at least one intervening layer or intervening structure is present between the first layer and the second layer.

“Ink” and like terms mean a coatable or printable formulation that can and usually does contain a dye and/or pigment. A nonlimiting example of a suitable ink is inkjet ink.

An “isocyanate” is a chemical that contains at least one isocyanate group in its structure. An isocyanate group (or NCO) is represented by the formula: —N═C═O. An isocyanate that has two isocyanate groups is a di-isocyanate and an isocyanate that has three isocyanate groups is a tri-isocyanate, etc. An isocyanate may be aromatic or aliphatic. In an embodiment, the isocyanate component is selected from a mono-isocyanate, a di-isocyanate, a tri-isocyanate, and combinations thereof.

An “isocyanate monomer” is a molecule that contains at least one isocyanate group and may chemically bind to other molecules to form a pre-polymer or a polymer.

An “isocyanate pre-polymer” is the reaction product of a monomer or system of monomers that contains at least one isocyanate group. A pre-polymer is a liquid intermediate between monomers and a final polymer. In an embodiment, polyurethane pre-polymers are formed by combining an excess amount of di-isocyanate with polyols.

“Layer” and like terms, as used herein, mean a single thickness, coating, or stratum of a compound, polymer, or composition spread out or covering a surface.

“Metal-detectable” refers to a compound or layer that is detectable via a metal detector and/or an X-ray. Nonlimiting examples of metal-detectable components include ferrous and nonferrous metals.

A “mordant” is a metal salt that fixes an ink in or on a substance by combining with the ink to form an insoluble compound. The metal salt may be mono-, di-, or tri-valent metal salts.

“Nonionic” refers to a compound or composition that has no net charge.

A “phenoxy resin” is a thermoplastic polymer derived from bisphenol A ((CH₃)₂C(C₆H₄OH)₂) and the epoxy, epichlorohydrin (Cl—CH₂—(C₂H₃O)). Phenoxy resins have the following basic repeating form:

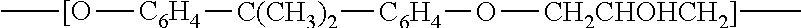

“Pigment” and like terms mean a visible light absorbing material or compound that is present in a non-molecularly dispersed (particulate) form.

A “polyester” is a polymer in which the polymer units are linked by ester groups. A nonlimiting example of a polyester is polyethylene terephthalate (PET).

A “polyester resin” is a resin in which the polymer units are linked by ester groups. The polyester resin may or may not be branched. A nonlimiting example of a polyester resin is a short oil alkyd resin.

A “polygon” is a closed-plane figure bounded by at least three sides. The polygon can be a regular polygon, or an irregular polygon having three, four, five, six, seven, eight, nine, ten, or more sides. Nonlimiting examples of suitable polygonal shapes include triangle, square, rectangle, diamond, trapezoid, parallelogram, hexagon, and octagon.

“Polymer” and like terms, as used herein, refer to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities, for example, catalyst residues, may be incorporated into and/or within the polymer. It also embraces all forms of interpolymers, e.g., random, block, homogeneous, heterogeneous, etc.

A “polyurethane” is a polymer formed of hydrocarbon units joined by urethane links (—NH—(C═O)—O—).

“Propylene-based polymer” as used herein, refers to a polymer that comprises, in polymerized form, a majority weight percent (wt %) of propylene monomer (based on the total weight of the polymer), and optionally may comprise one or more comonomers.

A “resin” is a polymer resin containing at least two functional groups. Nonlimiting examples of suitable resin include thermoplastic resins, thermosetting resins, and elastomers. Nonlimiting examples of suitable resin include polyester resin, phenoxy resin, and acrylic polyol resin.

A “short oil alkyd resin” is a polyester resin formed from polyhydric alcohols, polybasic acids, and fatty acids or fatty-acid glycerides. The percentage of fatty acids in a short oil alkyd resin is greater than 0% to less than 40% by weight.

“Silica” is an oxide of silicon with the chemical formula SiO₂. The silica may be organic silica or synthetic silica. The silica may be crystalline silica or amorphous silica. A nonlimiting example of an organic crystalline silica is quartz. Nonlimiting examples of synthetic amorphous silica include fumed silica, silica gel, precipitated silica, and colloidal silica.

A “vinyl” is a chemical that contains at least one vinyl group. A vinyl group is represented by the formula: —CH═CH₂.

Average particle size of the silica is measured in accordance with ASTM C721-20.

Color density is measured in accordance with CIE94 of ASTM D2244-21.

Hydroxyl number is measured in accordance with ASTM D4274.

Isocyanate group (NCO) content by weight is measured in accordance with ASTM D5155.

Oil absorption number is measured in accordance with ASTM D2414.

Solubility in water of a metal salt is measured as the concentration of dissolved salt in water on a mass/volume basis.

Weight average molecular weight (M_{w}) and number average molecular weight (Mₙ) are determined according to conventional gel permeation chromatography (GPC).

### DETAILED DESCRIPTION

The present disclosure provides a coating composition. In an embodiment, the coating composition contains (A) a resin having a hydroxyl number of at least 2; (B) a pigment; (C) a crosslinking agent comprising an isocyanate prepolymer; and (D) a solvent.

In another embodiment, the coating composition includes (E) an optional additive.

In some embodiments, the coating composition includes (F) an optional catalyst.

### A. Resin Having a Hydroxyl Number of at Least 2

The coating composition includes a resin having a hydroxyl number of at least 2.

Nonlimiting examples of suitable resin include polyester resin, phenoxy resin, acrylic polyol resin, and combinations thereof.

In an embodiment, the resin is a polyester resin. Nonlimiting examples of suitable polyester resin include Desmophen 670 BA, available from Covestro LLC; Adcote 3840D, available from The Dow Chemical Company; and short oil alkyd resin.

In an embodiment, the polyester resin is a short oil alkyd resin. In a further embodiment, the short oil alkyd resin is a tall oil fatty acid (TOFA) alkyd resin. A nonlimiting example of a suitable TOFA alkyd resin is Chempol 809-2837, available from Arkema Coating Resins.

In an embodiment, the resin is a phenoxy resin. A nonlimiting example of a suitable phenoxy resin is Phenoxy PK HH, available from Huntsman Advanced Materials.

In an embodiment, the resin is an acrylic polyol resin. A nonlimiting example of a suitable acrylic polyol resin is Chempol 317-3867, available from Arkema Coating Resins.

The resin has a hydroxyl number of at least 2. In some embodiments, the resin has a hydroxyl number of at least 3, or at least 3.5, or at least 10, or at least 50, or at least 100, or at least 200. In another embodiment, the resin has a hydroxyl number of from 2, or 3, or 3.5, or 10 to 20, or 40, or 50, or 90, or 100, or 150, or 200, or 250, or 300. In another embodiment, the resin has a hydroxyl number of from 2 to 300, or from 3 to 300, or from 3.5 to 250, or from 3.5 to 200, or from 3.5 to 150, or from 3.5 to 100, or from 3.5 to 95, or from 3.5 to 87, or from 3.5 to 10, or from 2 to 3.5, or from 10 to 200, or from 10 to 100, or from 10 to 95, or from 10 to 87, or from 50 to 200, or from 50 to 100, or from 87 to 200, or from 87 to 95, or from 95 to 200. In a further embodiment, the resin has a hydroxyl number of 3.5.

In an embodiment, the resin has a molecular weight (M_{w}) from 1,600 g/mol to 60,000 g/mol.

In an embodiment, the resin has a number average molecular weight (Mₙ) from 1,600 g/mol to 60,000 g/mol.

In an embodiment, the resin is a polyester resin, a phenoxy resin, an acrylic polyol resin, or a combination thereof. The resin has a hydroxyl number of at least 2, or at least 3, or at least 3.5, or at least 10, or at least 50, or at least 100, or at least 200. In another embodiment, the resin has a hydroxyl number of from 2 to 300, or from 3 to 300, or from 3.5 to 250, or from 3.5 to 200, or from 3.5 to 150, or from 3.5 to 100, or from 3.5 to 95, or from 3.5 to 87, or from 3.5 to 10, or from 2 to 3.5, or from 10 to 200, or from 10 to 100, or from 10 to 95, or from 10 to 87, or from 50 to 200, or from 50 to 100, or from 87 to 200, or from 87 to 95, or from 95 to 200. In some embodiments, the resin has a molecular weight (M_{w}) from 1,600 g/mol to 60,000 g/mol and/or a number average molecular weight (Mₙ) from 1,600 g/mol to 60,000 g/mol.

The resin may comprise two or more embodiments disclosed herein.

### B. Pigment

The coating composition includes a pigment.

Nonlimiting examples of suitable pigment include silica, titanium dioxide, calcium carbonate, magnesium silicate, talc, aluminum hydroxide, and combinations thereof.

In an embodiment, the pigment is a silica. In an embodiment, the silica is a synthetic silica. In another embodiment, the silica is an amorphous silica. In a further embodiment, the silica is a synthetic amorphous silica. Nonlimiting examples of suitable synthetic amorphous silica include fumed silica, silica gel, precipitated silica, colloidal silica, and combinations thereof. A nonlimiting example of synthetic amorphous silica is synthetic amorphous silicon dioxide. Nonlimiting examples of suitable synthetic amorphous silica dioxide include Lo-vel 6000, available from PPG Industries, Inc.; Syloid C-805, available from W.R. Grace & Co.; and Acematt OK 412, available from Evonik Resource Efficiency GmbH.

In an embodiment, the pigment is a calcium carbonate. A nonlimiting example of a suitable calcium carbonate is a precipitated calcium carbonate. A nonlimiting example of a precipitate calcium carbonate is Albacar 5970, available from Specialty Minerals Inc.

In an embodiment, the pigment is titanium dioxide. A nonlimiting example of titanium dioxide is a rutile titanium dioxide dispersion. A nonlimiting example of a rutile titanium dioxide dispersion is Tint-AYD ST 8003, available from Chromaflo Technologies Corporation.

In an embodiment, the pigment is aluminum hydroxide. A nonlimiting example of aluminum hydroxide is finely-precipitated aluminum hydroxide. A nonlimiting example of finely-precipitated aluminum hydroxide is Martinal OL-107, available from Huber Engineered Materials.

In an embodiment, the pigment is a blend of two or more silica.

In an embodiment, the pigment is a blend of a first pigment and a second pigment. The first pigment is a silica and the second pigment is selected from titanium dioxide, calcium carbonate, magnesium silicate, talc, aluminum hydroxide, and combinations thereof. The first pigment that is a silica may be a single silica, or a blend of two or more silica. The dry mass ratio of the second pigment to the first pigment (i.e., Second Pigment Dry Mass/First Pigment Dry Mass) is from 0.25 to 3, or from 0.5 to 1.5. In another embodiment, the dry mass ratio of the second pigment to the first pigment is from 0.25, or 0.5 to 1.0, or 1.5, or 2.0, or 2.5, or 3.0.

In another embodiment, the pigment is a single type of silica, or further a single type of synthetic amorphous silica. In other words, the coating composition contains a single pigment that is a single (or one) type of silica, or further a single type of synthetic amorphous silica.

In some embodiments, the pigment has a mean particle size of from 1 to 50 microns, or from 5 to 50 microns, or from 5 to 25 microns, or from 1 to 25 microns, or from 1 to 15 microns, or from 1 to 10 microns, or from 3 to 10 microns, or from 5 to 10 microns. In another embodiment, the pigment has a mean particle size of from 1 micron, or 2.5 microns, or 3 microns, or 5 microns to 9.5 microns, or 10 microns, or 15 microns, or 20 microns, or 25 microns, or 30 microns, or 40 microns, or 50 microns.

In an embodiment, the pigment has an oil absorption number of from 15 to 350 g oil/100 g pigment, or from 100 to 250 g oil/100 g pigment, or from 50 to 350 g oil/100 g pigment, or from 50 to 300 g oil/100 g pigment, or from 100 to 350 g oil/100 g pigment, or from 100 to 250 g oil/100 g pigment, or from 100 to 200 g oil/100 g pigment, or from 50 to 315 g oil/100 g pigment, or from 240 to 315 g oil/100 g pigment, or from 200 to 315 g oil/100 g pigment, or from 240 to 270 g oil/100 g pigment. In another embodiment the pigment has an oil absorption number of from 15, or 20, or 25, or 40, or 50, or 100, or 150, or 200, or 240 to 250, or 300, or 350 g oil/100 g pigment.

In an embodiment, the pigment is a silica, or further a synthetic amorphous silica. In a further embodiment, the silica has a mean particle size of from 1 to 50 microns, or from 5 to 50 microns, or from 5 to 25 microns, or from 1 to 25 microns, or from 1 to 15 microns, or from 1 to 10 microns, or from 3 to 10 microns, or from 5 to 10 microns; and/or an oil absorption number of from 15 to 350 g oil/100 g pigment, or from 100 to 250 g oil/100 g pigment, or from 50 to 350 g oil/100 g pigment, or from 50 to 300 g oil/100 g pigment, or from 100 to 350 g oil/100 g pigment, or from 100 to 250 g oil/100 g pigment, or from 100 to 200 g oil/100 g pigment, or from 50 to 315 g oil/100 g pigment, or from 240 to 315 g oil/100 g pigment, or from 200 to 315 g oil/100 g pigment, or from 240 to 270 g oil/100 g pigment.

In another embodiment, the pigment a blend of a first pigment and a second pigment. The first pigment is a silica and the second pigment is selected from titanium dioxide, calcium carbonate, magnesium silicate, talc, aluminum hydroxide, and combinations thereof. The dry mass ratio of the second pigment to the first pigment (i.e., Second Pigment Dry Mass/First Pigment Dry Mass) is from 0.25 to 3, or from 0.5 to 1.5. In another embodiment, the dry mass ratio of the second pigment to the first pigment is from 0.25, or 0.5 to 1.0, or 1.5, or 2.0, or 2.5, or 3.0. The first pigment may be a synthetic amorphous silica with a mean particle size of from 1 to 50 microns, or from 5 to 50 microns, or from 5 to 25 microns, or from 1 to 25 microns, or from 1 to 15 microns, or from 1 to 10 microns, or from 3 to 10 microns, or from 5 to 10 microns; and/or an oil absorption number of from 15 to 350 g oil/100 g pigment, or from 100 to 250 g oil/100 g pigment, or from 50 to 350 g oil/100 g pigment, or from 50 to 300 g oil/100 g pigment, or from 100 to 350 g oil/100 g pigment, or from 100 to 250 g oil/100 g pigment, or from 100 to 200 g oil/100 g pigment, or from 50 to 315 g oil/100 g pigment, or from 240 to 315 g oil/100 g pigment, or from 200 to 315 g oil/100 g pigment, or from 240 to 270 g oil/100 g pigment. In some embodiments, the second pigment has a mean particle size of from 1 to 50 microns, or from 5 to 50 microns, or from 5 to 25 microns, or from 1 to 25 microns, or from 1 to 15 microns, or from 1 to 10 microns, or from 3 to 10 microns, or from 5 to 10 microns; and/or an oil absorption number of from 15 to 350 g oil/100 g pigment, or from 100 to 250 g oil/100 g pigment, or from 50 to 350 g oil/100 g pigment, or from 50 to 300 g oil/100 g pigment, or from 100 to 350 g oil/100 g pigment, or from 100 to 250 g oil/100 g pigment, or from 100 to 200 g oil/100 g pigment, or from 50 to 315 g oil/100 g pigment, or from 240 to 315 g oil/100 g pigment, or from 200 to 315 g oil/100 g pigment, or from 240 to 270 g oil/100 g pigment.

The pigment may comprise two or more embodiments disclosed herein.

### C. Crosslinking Agent

The coating composition includes a crosslinking agent. A “crosslinking agent” is a compound or composition that is a reagent with at least two reactive ends capable of chemically attaching to resin molecules. The crosslinking agent includes an isocyanate prepolymer.

The crosslinking agent may be aliphatic or aromatic. Nonlimiting examples of suitable isocyanate prepolymers are buriets, isocyanurates, and trimers.

In an embodiment, the crosslinking agent is an aliphatic isocyanate prepolymer. Nonlimiting examples of suitable aliphatic isocyanate prepolymers include aliphatic polyisocyanate (HDI biuret) and aliphatic polyisocyanate (HDI trimer). A nonlimiting example of aliphatic polyisocyanate (HDI biuret) is Desmodur N75 BA/X, available from Covestro LLC. A nonlimiting example of aliphatic polyisocyanate (HDI trimer) is Desmodur N330 BA/SN, available from Covestro LLC.

In an embodiment, the crosslinking agent is an aromatic polyisocyanate. A nonlimiting example of a suitable aromatic polyisocyanate is Desmodur L 67 MPA/X, available from Covestro LLC

In an embodiment, the isocyanate prepolymer has an NCO content of at least 2.5%, or at least 5%, or at least 10%, or at least 15%, or at least 16%. In another embodiment, the isocyanate prepolymer has an NCO content of from 2.5%, or 5%, or 10%, or 15%, or 16% to 20%, or 25%, or 30%, or 50%. In another embodiment, the isocyanate prepolymer has an NCO content of from 2.5% to 50%, or from 5% to 30%, or from 10% to 30%, or from 15% to 30%, or from 15% to 25%, or from 15% to 20%, or from 16% to 20%.

In an embodiment, the crosslinking agent is an aliphatic isocyanate prepolymer. The aliphatic isocyanate prepolymer has an NCO content of from 2.5% to 50%, or from 5% to 30%, or from 10% to 30%, or from 15% to 30%, or from 15% to 25%, or from 15% to 20%, or from 16% to 20%.

The crosslinking agent may comprise two or more embodiments disclosed herein.

### D. Solvent

The coating composition includes a solvent.

In an embodiment, the resin and the crosslinking agent are soluble in the solvent. In other words, the resin and the crosslinking agent are each substantially dissolved, or fully dissolved in the solvent. The resin and crosslinking agent remain substantially or fully dissolved in the solvent over time without requiring the addition of heat and/or agitation.

Nonlimiting examples of suitable solvents include n-butyl acetate, methyl n-amyl ketone, xylene, cyclohexanone, N-methyl-2-pyrrolidone (“NMP”), toluene, 1,3-dioxolane, methoxypropyl acetate, naptha, water (e.g., deionized water), and combinations thereof.

In an embodiment, the solvent excludes water. In other words, the coating composition is void of water.

In an embodiment, the solvent is selected from n-butyl acetate, methyl n-amyl ketone, xylene, cyclohexanone, N-methyl-2-pyrrolidone (“NMP”), toluene, and combinations thereof.

In another embodiment, the solvent is selected from n-butyl acetate, methyl n-amyl ketone, xylene, cyclohexanone, N-methyl-2-pyrrolidone (“NMP”), toluene, 1,3-dioxolane, methoxypropyl acetate, naptha, and combinations thereof.

In an embodiment, the solvent is a blend of n-butyl acetate, methyl n-amyl ketone, and xylene.

In an embodiment, the solvent is a blend of xylene and cyclohexanone.

In an embodiment, the solvent is a blend of NMP and toluene.

The solvent may comprise two or more embodiments disclosed herein.

### E. Optional Additive

In some embodiments, the coating composition includes an optional additive.

Nonlimiting examples of suitable optional additives include surfactants, dispersing agents, rheology modifiers, wetting agents, leveling agents, defoaming agents, slip agents, moisture scavengers, and combinations thereof.

Nonlimiting examples of suitable additives include polyacrylates, polysiloxanes, modified urethanes, hydrophobic silicas, silicones, mineral oils, and combinations thereof.

In an embodiment, the coating composition includes a surfactant. Nonlimiting examples of surfactants include anionic surfactants, cationic surfactants, nonionic surfactants, and Zwitterionic surfactants. In an embodiment, the surfactant is a nonionic surfactant. A nonlimiting example of a nonionic surfactant is isopropyl alcohol (e.g., Surfynol 104 Pa, available from Evonik Corporation). Nonlimiting examples of suitable surfactants include isopropyl alcohol (e.g., Surfynol 104 Pa, available from Evonik Corporation), polyether-modified polydimethylsiloxane (e.g., Byk-3455, available from Byk-Chemic GmbH), and combinations thereof.

In an embodiment, the coating composition includes a surfactant that is a wetting and leveling agent, such as a polyether-modified polydimethylsiloxane (e.g., Byk-3455 and Byk-333, each available from Byk-Chemic GmbH).

Nonlimiting examples of suitable dispersing agents are modified styrene maleic acid copolymer (e.g., Disperbyk-190, available from Byk-Chemic GmbH) and modified polyurethane (Disperbyk-2164, available from Byk-Chemic GmbH).

Nonlimiting examples of suitable rheology modifiers include hydrophobically modified ethylene oxide urethane (e.g., Acrysol RM-12W, available from The Dow Chemical Company) and a sodium salt of an acrylic copolymer (e.g., Texipol 63-934, available from ScottBader Co. Ltd.).

A nonlimiting example of a suitable moisture scavenger is Additive OF (Borchers).

A nonlimiting example of a suitable defoaming agent is Byk-A 530 (Byk-Chemic GmbH)

In an embodiment, the coating composition includes a surfactant and a dispersing agent. In a further embodiment, the surfactant is a polyether-modified polydimethylsiloxane and the dispersing agent is a modified polyurethane.

In an embodiment, the coating composition includes a surfactant, a dispersing agent, a moisture scavenger, and a defoaming agent. In a further embodiment, the surfactant is a polyether-modified polydimethylsiloxane and the dispersing agent is a modified polyurethane.

The optional additive may comprise two or more embodiments disclosed herein.

### F. Coating Composition

The coating composition includes (A) a resin having a hydroxyl number of at least 2; (B) a pigment; (C) a crosslinking agent comprising an isocyanate prepolymer; and (D) a solvent.

In some embodiments, the coating composition includes the coating composition contains (A) a resin having a hydroxyl number of at least 2; (B) a pigment; (C) a crosslinking agent comprising an isocyanate prepolymer; (D) a solvent; and € an optional additive.

In some embodiments, the coating composition includes the coating composition contains (A) a resin having a hydroxyl number of at least 2; (B) a pigment; (C) a crosslinking agent comprising an isocyanate prepolymer; (D) a solvent; € an optional additive; and (F) a catalyst.

In an embodiment, the coating composition includes a catalyst. Nonlimiting examples of suitable catalysts include dibutyltin dilaurate, dibutyltin diacetate, bismuth, zirconium, aluminum, zinc, and combinations thereof. In an embodiment, the catalyst is dibutyltin dilaurate. A nonlimiting example of dibutyltin dilaurate is Dabco T-12, available from Evonik, Inc.

In an embodiment, the coating composition includes from 5 wt % to 50 wt %, or from 5 wt % to 20 wt %, or from 10 wt % to 20 wt %, or from 10 wt % to 25 wt %, or from 10 wt % to 50 wt %, or from 10 wt % to 30 wt %, or from 5 wt % to 30 wt %, or from 10 wt % to 30 wt % resin, based on the total weight of the coating composition. In another embodiment, the composition includes from 5 wt %, or 10 wt %, or 15 wt % to 20 wt %, or 25 wt %, or 30 wt %, or 35 wt %, or 40 wt %, or 45 wt %, or 50 wt % resin, based on the total weight of the coating composition.

In an embodiment, the coating composition includes from 5 wt %, or 8 wt %, or 10 wt % to 12 wt %, or 14 wt %, or 15 wt %, or 18 wt %, or 19 wt %, or 20 wt %, or 25 wt %, or 30 wt % pigment, based on the total weight of the composition. In another embodiment, the coating composition includes from 5 wt % to 30 wt %, or from 5 wt % to 25 wt %, or from 5 wt % to 20 wt %, or from 8 wt % to 18 wt % pigment, based on the total weight of the composition.

In another embodiment, pigment is a blend of a first pigment and a second pigment. The first pigment is a silica and the second pigment is selected from titanium dioxide, calcium carbonate, magnesium silicate, talc, aluminum hydroxide, and combinations thereof. The first pigment that is a silica may be a single silica, or a blend of two or more silica. The dry mass ratio of the second pigment to the first pigment (i.e., Second Pigment Dry Mass/First Pigment Dry Mass) is from 0.25 to 3, or from 0.5 to 1.5. In another embodiment, the dry mass ratio of the second pigment to the first pigment is from 0.25, or 0.5 to 1.0, or 1.5, or 2.0, or 2.5, or 3.0. The coating composition includes from 5 wt %, or 8 wt %, or 10 wt % to 12 wt %, or 14 wt %, or 15 wt %, or 18 wt %, or 19 wt %, or 20 wt %, or 25 wt %, or 30 wt % pigment (i.e., the combined amount of first pigment and second pigment), based on the total weight of the composition. In another embodiment, the coating composition includes from 5 wt % to 30 wt %, or from 5 wt % to 25 wt %, or from 5 wt % to 20 wt %, or from 8 wt % to 18 wt % pigment, based on the total weight of the composition.

In another embodiment, the composition contains a single type of pigment that is a synthetic amorphous silica. The coating composition contains from 5 wt %, or 8 wt %, or 10 wt % to 12 wt %, or 14 wt %, or 15 wt %, or 18 wt %, or 19 wt %, or 20 wt %, or 25 wt %, or 30 wt % synthetic amorphous silica, based on the total weight of the composition. In another embodiment, the coating composition includes from 5 wt % to 30 wt %, or from 5 wt % to 25 wt %, or from 5 wt % to 20 wt %, or from 8 wt % to 18 wt %, or from 8 wt % to 10 wt % synthetic amorphous silica, based on the total weight of the composition. In a further embodiment, the coating composition is void of a second pigment.

In an embodiment, the coating composition contains from 0.5 wt % to 30 wt %, or from 1 wt % to 30 wt %, or from 2 wt % to 30 wt %, or from 2 wt % to 25 wt %, or from 1 wt % to 25 wt %, or from 1 wt % to 20 wt %, or from 2 wt % to 20 wt %, or from 2 wt % to 15 wt %, or from 1 wt % to 15 wt %, or from 2 wt % to 13 wt % crosslinking agent, based on the total weight of the coating composition. In a further embodiment, the coating composition contains from 0.5 wt %, or 1 wt %, or 1.5 wt %, or 2 wt %, or 2.5 wt %, or 5 wt %, or 9 wt % to 13 wt %, or 15 wt %, or 20 wt %, or 25 wt %, or 30 wt % crosslinking agent, based on the total weight of the coating composition.

In an embodiment, the coating composition contains from 15 wt % to 80 wt %, or from 30 wt % to 80 wt %, or from 40 wt % to 70 wt %, or from 50 wt % to 70 wt %, or from 55 wt % to 65 wt % solvent, based on the total weight of the coating composition. In another embodiment, the coating composition contains from 15 wt %, or 20 wt %, or 25 wt %, or 30 wt %, or 35 wt %, or 40 wt %, or 45 wt %, or 50 wt %, or 55 wt %, or 60 wt % to 65 wt %, or 70 wt %, or 75 wt %, or 80 wt % solvent, based on the total weight of the coating composition.

In an embodiment, the coating composition includes from 0.01 wt % to 5 wt %, or from 0.01 wt % to 2 wt %, or from 0.01 wt % to 0.50 wt %, or from 0.01 wt % to 0.01 wt % catalyst, based on the total weight of the coating composition.

In an embodiment, the coating composition contains from 0.1 wt % to 5 wt %, or from 0.1 wt % to 3 wt %, or from 0.1 wt % to 1.5 wt %, or from 0.3 wt % to 0.9 wt % additive, based on the total weight of the coating composition. In a further embodiment, the coating composition contains from 0.1 wt %, or 0.2 wt %, or 0.3 wt % to 0.4 wt %, or 0.5 wt %, or 0.7 wt %, or 0.8 wt %, or 1.0 wt %, 1.2 wt %, or 1.5 wt %, or 2 wt %, or 3 wt %, or 4 wt %, or 5 wt % additive, based on the total weight of the coating composition.

In an embodiment, the coating composition contains from 0.1 wt % to 5 wt %, or from 0.1 wt % to 3 wt %, or from 0.1 wt % to 1.5 wt %, or from 0.3 wt % to 0.9 wt % dispersing agent, based on the total weight of the coating composition. In a further embodiment, the coating composition contains from 0.1 wt %, or 0.2 wt %, or 0.3 wt % to 0.4 wt %, or 0.5 wt %, or 0.7 wt %, or 0.8 wt %, or 1.0 wt %, 1.2 wt %, or 1.5 wt %, or 2 wt %, or 3 wt %, or 4 wt %, or 5 wt % dispersing agent, based on the total weight of the coating composition.

In an embodiment, the composition has a total solids content of from 20 wt % to 70 wt %, or from 20 wt % to 60 wt %, or from 20 wt % to 50 wt %, or from 30 wt % to 50 wt %, or from 30 wt % to 40 wt %, or from 50 wt % to 60 wt %, based on the total weight of the coating composition. In another embodiment, the composition has a total solids content of from 20 wt %, or 25 wt %, or 30 wt %, or 35 wt %, or 40 wt % to 45 wt %, or 50 wt %, or 55 wt %, or 60 wt %, or 65 wt %, or 70 wt %, based on the total weight of the coating composition.

In an embodiment, the coating composition contains (A) from 5 wt % to 50 wt %, or from 5 wt % to 20 wt %, or from 10 wt % to 20 wt %, or from 10 wt % to 25 wt %, or form 10 wt % to 50 wt %, or from 10 wt % to 30 wt %, or from 5 wt % to 30 wt %, or from 10 wt % to 30 wt % resin having a hydroxyl number of at least 2; (B) from 5 wt % to 30 wt %, or from 5 wt % to 25 wt %, or from 5 wt % to 20 wt %, or from 8 wt % to 18 wt % pigment; (C) from 0.5 wt %, or 1 wt %, or 1.5 wt %, or 2 wt %, or 2.5 wt %, or 5 wt %, or 9 wt % to 13 wt %, or 15 wt %, or 20 wt %, or 25 wt %, or 30 wt % crosslinking agent including an isocyanate prepolymer; (D) from 15 wt % to 80 wt %, or from 30 wt % to 80 wt %, or from 40 wt % to 70 wt %, or from 50 wt % to 70 wt %, or from 55 wt % to 65 wt % solvent; optionally, € from 0.1 wt %, or 0.2 wt %, or 0.3 wt % to 0.4 wt %, or 0.5 wt %, or 0.7 wt %, or 0.8 wt %, or 1.0 wt %, or 1.2 wt %, or 1.5 wt %, or 2 wt %, or 3 wt %, or 4 wt %, or 5 wt % additive (e.g., dispersing agent); and optionally, (F) from 0.01 wt % to 5 wt %, or from 0.01 wt % to 2 wt %, or from 0.01 wt % to 0.50 wt %, or from 0.01 wt % to 0.01 wt % catalyst based on the total weight of the coating composition. In a further embodiment, the coating composition has one, some, or all of the following properties:
(i) the resin is a polyester resin, a phenoxy resin, an acrylic polyol resin, or a combination thereof; and/or
(ii) the resin has a hydroxyl number of from 2 to 300, or from 3 to 300, or from 3.5 to 250, or from 3.5 to 200, or from 3.5 to 150, or from 3.5 to 100, or from 3.5 to 95, or from 3.5 to 87, or from 3.5 to 10, or from 2 to 3.5, or from 10 to 200, or from 10 to 100, or from 10 to 95, or from 10 to 87, or from 50 to 200, or from 50 to 100, or from 87 to 200, or from 87 to 95, or from 95 to 200; and/or
(iii) the resin has a molecular weight (M_{w}) from 1,600 g/mol to 60,000 g/mol; and/or
(iv) the resin has a number average molecular weight (Mₙ) from 1,600 g/mol to 60,000 g/mol; and/or
(v) the pigment is selected from a silica, titanium dioxide, calcium carbonate, magnesium silicate, talc, aluminum hydroxide, and combinations thereof; and/or
(vi) the coating composition contains one and only one pigment that is a synthetic amorphous silica; and/or
(vii) the pigment is a blend of a first pigment and a second pigment, wherein the first pigment is a silica and the second pigment is selected from titanium dioxide, calcium carbonate, magnesium silicate, talc, aluminum hydroxide, and combinations thereof and the dry mass ratio of the second pigment to the first pigment (i.e., Second Pigment Dry Mass/First Pigment Dry Mass) is from 0.25 to 3, or from 0.5 to 1.5; and/or
(viii) the pigment has a mean particle size of from 1 to 50 microns, or from 5 to 50 microns, or from 5 to 25 microns, or from 1 to 25 microns, or from 1 to 15 microns, or from 1 to 10 microns, or from 3 to 10 microns, or from 5 to 10 microns; and/or
(ix) the pigment has an oil absorption number of from 15 to 350 g oil/100 g pigment, or from 100 to 250 g oil/100 g pigment, or from 50 to 350 g oil/100 g pigment, or from 50 to 300 g oil/100 g pigment, or from 100 to 350 g oil/100 g pigment, or from 100 to 250 g oil/100 g pigment, or from 100 to 200 g oil/100 g pigment, or from 50 to 315 g oil/100 g pigment, or from 240 to 315 g oil/100 g pigment, or from 200 to 315 g oil/100 g pigment, or from 240 to 270 g oil/100 g pigment; and/or
(x) the isocyanate prepolymer is an aliphatic isocyanate prepolymer; and/or
(xi) the isocyanate prepolymer has an NCO content of from 2.5% to 50%, or from 5% to 30%, or from 10% to 30%, or from 15% to 30%, or from 15% to 25%, or from 15% to 20%, or from 16% to 20%; and/or
(xii) the solvent is selected from n-butyl acetate, methyl n-amyl ketone, xylene, cyclohexanone, N-methyl-2-pyrrolidone (“NMP”), toluene, 1,3-dioxolane, methoxypropyl acetate, naptha, water (e.g., deionized water), and combinations thereof; and/or
(xiii) the solvent is selected from n-butyl acetate, methyl n-amyl ketone, xylene, cyclohexanone, N-methyl-2-pyrrolidone (“NMP”), toluene, 1,3-dioxolane, methoxypropyl acetate, naptha, and combinations thereof; and/or
(xiv) the coating composition is void of water and/or
(xv) the additive is selected from a surfactant, a dispersing agent, or a combination thereof; and/or
(xvi) the additive is selected from a surfactant, a dispersing agent, a defoaming agent, or a combination thereof; and/or
(xvii) the catalyst is selected from dibutyltin dilaurate, dibutyltin diacetate, bismuth, zirconium, aluminum, zinc, and combinations thereof; and/or
(xviii) the coating composition has a total solids content of from 20 wt % to 70 wt %, or from 20 wt % to 60 wt %, or from 20 wt % to 50 wt %, or from 30 wt % to 50 wt %, or from 30 wt % to 40 wt %, or from 50 wt % to 60 wt %, based on the total weight of the coating composition.

It is understood that the total cumulative weight percent of the above-described coating compositions, and every composition disclosed herein, is 100 wt %.

The present disclosure provides a method of forming a coating composition including: (A) mixing the resin having a hydroxyl number of at least 2, the pigment, the solvent, and the dispersant to form a composition; and (B) mixing the crosslinking agent comprising an isocyanate prepolymer with the composition under reactive conditions to form the coating composition.

A nonlimiting example of “reactive conditions” are mixing the components with the catalyst for a period of time. Before the coating composition is exposed to reactive conditions, the coating composition is a crosslinkable coating composition. After the coating composition is exposed to reactive conditions, the coating composition is a crosslinked, or a substantially crosslinked, coating composition.

In an embodiment, the coating composition is formed by blending the resin, pigment, solvent, and optionally, an additive (e.g., a dispersing agent) together, and then adding the crosslinking agent, additional solvent, and a catalyst to the blend and mixing. The components of the coating composition are mixed under reactive conditions to form the coating composition.

The coating composition may comprise two or more embodiments disclosed herein.

### G. Coated Label

The present disclosure provides a coated label. The coated label includes (A) a polymeric substrate having a top surface and an opposing bottom surface; (B) an adhesive layer in contact with the bottom surface of the polymeric substrate; and (C) a coating layer in contact with the top surface of the polymeric substrate, the coating layer formed from a coating composition containing (i) a resin having a hydroxyl number of at least 2; (ii) a pigment; (iii) a crosslinking agent comprising an isocyanate prepolymer; and (iv) a solvent.

The coating composition, the resin, the pigment, the crosslinking agent, and the solvent may be any coating composition, resin, pigment, crosslinking agent, and solvent disclosed herein.

In some embodiments, the coated label includes an optional metal-detectable layer between the polymeric substrate and the adhesive layer.

In some embodiments, the coated label includes (D) an optional release liner in contact with the adhesive layer.

The coating layer may be formed from any coating composition disclosed herein.

### H. Coating Layer

The coated label includes a coating layer. The coating layer has a top surface and an opposing bottom surface. The bottom surface of the coating layer contacts the top surface of the polymeric substrate.

The coating layer formed from a coating composition containing (i) a resin having a hydroxyl number of at least 2; (ii) a pigment; (iii) a crosslinking agent comprising an isocyanate prepolymer; and (iv) a solvent. The coating composition may be any coating composition disclosed herein.

In an embodiment, the coating composition is a crosslinked coating composition.

In an embodiment, the coating layer (after drying) has a thickness of from 56 μm (2.2 mil) to 66 μm (2.6 mil), or from 60 μm to 65 μm, or is 61 μm (22.4 mil).

In an embodiment, the coating layer (after drying) has a dry coating weight of from 15 pounds/ream to 50 pounds/ream, or from 20 pounds/ream to 40 pounds/ream, or from 25 pounds/ream to 35 pounds/ream.

In an embodiment, the coating layer has a substantially uniform thickness from each edge surface to the opposing edge surface. In a coating layer having substantially uniform thickness from each edge surface to the opposing edge surface, the top surface and the opposing bottom surface extend parallel to each other.

The coating layer may directly or indirectly contact the polymeric substrate. In an embodiment, the coating layer indirectly contacts the polymeric substrate. In another embodiment, the coating layer directly contacts the polymeric substrate.

In some embodiments, the coating layer is the top facial surface of the coated label. In other words, the top surface of the coating layer is the top facial surface of the coated label. The coating layer is therefore exposed to ambient environment.

The coating layer may comprise two or more embodiments disclosed herein.

### I. Polymeric Substrate

The coated label includes a polymeric substrate having a top surface and an opposing bottom surface.

The polymeric substrate may be a single-layer or a multi-layer structure. In an embodiment, the polymeric substrate is a single-layer structure containing one layer formed from a polymer.

In another embodiment, the polymeric substrate is a multi-layer structure containing at least one layer formed from a polymer.

The polymeric substrate includes at least one layer formed from, or containing, a polymer. Nonlimiting examples of suitable polymers include polyolefins, polyamides, vinyl polymers, and polyesters. In an embodiment, the polymer is a polyester (e.g., PET), a propylene-based polymer (e.g., polypropylene), an ethylene-based polymer, a vinyl polymer (e.g., polyvinyl chloride or “PVC”), or a combination thereof. In a further embodiment, the polymer is a polyester. In another embodiment, the polymer is a propylene-based polymer.

In an embodiment, the polymeric substrate is a multi-layer structure containing at least one layer formed from a polyester. A nonlimiting example of a suitable multi-layer structure is the label disclosed in U.S. Pat. No. 8,920,895, the entire contents of which are hereby incorporated by reference herein. In U.S. Pat. No. 8,920,895, a polyester face sheet layer is in contact with a topcoat layer and a detectable layer. In some embodiments, the polymeric substrate is a multi-layer structure including a topcoat in contact with a polyester film, which contacts a detectable layer.

In another embodiment, the polymeric substrate is a single layer film. In some embodiments, the film is a polyester film. A nonlimiting example of a suitable polyester film is Melinex 329, available from DuPont Teijin Films.

In an embodiment, the layer (or film) formed from the polymer has a thickness of from 0.5 μm to 15 μm, or from 1 μm to 15 μm, or from 5 μm to 15 μm, or from 1 μm to 5 μm, or from 5 μm to 13 μm. In another embodiment, the layer (or film) formed from the polymer has a thickness of from 0.5 μm, or 1 μm, or 5 μm to 10 μm, or 15 μm. The thickness of the layer (or film) formed from the polymer excludes the thickness of any other layers or coatings that may be present in a multi-layer polymeric substrate structure.

In an embodiment, the polymeric substrate has a substantially uniform thickness from each edge surface to the opposing edge surface. In a polymeric substrate having substantially uniform thickness from each edge surface to the opposing edge surface, the top surface and the opposing bottom surface extend parallel to each other.

The polymeric substrate may comprise two or more embodiments disclosed herein.

### J. Adhesive Layer

The coated label includes an adhesive layer in contact with the bottom surface of the polymeric substrate.

The adhesive layer has a top surface and an opposing bottom surface.

The adhesive layer may directly or indirectly contact the polymeric substrate.

In an embodiment, the polymeric substrate directly contacts the adhesive layer. In other words, the bottom surface of the polymeric substrate directly contacts the top surface of the adhesive layer. In another embodiment, the polymeric substrate indirectly contacts the adhesive layer.

The adhesive layer is used to attach the label to the end-use surface.

In an embodiment, the adhesive layer is configured to directly contact an end-use surface when the coated label is placed on the end-use surface. In other words, the bottom surface of the adhesive layer is configured to directly contact an end-use surface when the coated label is placed on, or in direct contact with, the end-use surface.

In an embodiment, the adhesive layer directly contacts the optional release liner, which is described in detail below. In other words, the bottom surface of the adhesive layer directly contacts a top surface of the release liner.

A nonlimiting example of a suitable adhesive is a pressure-sensitive adhesive (“PSA”). Nonlimiting examples of suitable pressure sensitive adhesives include acrylic-based PSAs, acrylic-hybrid PSAs, rubber-based PSAs, silicone-based PSAs, and combinations thereof. The PSA may be thermoplastic, solvent-based, or water-based.

In an embodiment, the PSA is an acrylic-based PSA. Acrylic-based PSAs are formed from an acrylic-based polymer. Nonlimiting examples of suitable acrylic-based PSAs are LOCTITE™ DURO-TAK 230A, available from Henkel.

In an embodiment, the PSA is an acrylic-hybrid PSA. Nonlimiting examples of suitable acrylic hybrids include acrylic-rubber hybrid and acrylic-silicone hybrid PSAs. In an embodiment, the acrylic-hybrid PSA is an acrylic-rubber PSA. A nonlimiting example of a suitable acrylic-rubber PSA is LOCTITE™ DURO-TAK AH 115, available from Henkel.

In an embodiment, the PSA is a rubber-based PSA. Nonlimiting examples of suitable rubber-based PSAs include compositions containing (i) one or more polymers such as styrene-butadiene (SBR), styrenic block copolymer (such as polystyrene-polyisoprene-polystyrene (SIS) or polystyrene-polybutadiene-polystyrene (SBS)), and butyl rubber; and (ii) an optional tackifying resin such as polyisobutylene. Nonlimiting examples of suitable rubber-based PSAs include MORSTIK™ 123 and 190, available from The Dow Chemical Company; and Thermogrip™ 9492KN, available from Bostik. In an embodiment, the PSA is a rubber-based PSA containing butyl rubber, such as Thermogrip™ 9492KN.

In an embodiment, the PSA is selected from an acrylic-based PSA, an acrylic-hybrid PSA, a rubber-based PSA, and combinations thereof.

In an embodiment, the PSA is a rubber-based acrylic PSA.

In an embodiment, the PSA is an acrylic-based PSA.

In an embodiment, the PSA includes one or more optional additives. A nonlimiting example of a suitable additive is a pigment, such as titanium dioxide. The pigment in the adhesive layer may be the same or different than the pigment in the coating composition.

Nonlimiting examples of an adhesive are the adhesives disclosed in U.S. Pat. No. 8,920,895 and U.S. Publication No. 2019/0210391, the entire contents of which are hereby incorporated by reference herein.

In an embodiment, the adhesive layer has a thickness of from 0.1 μm to 10 μm, or from 0.1 μm to 5 μm, or from 0.1 μm to 3 μm, or from 0.5 μm to 3 μm, or from 0.5 μm to 2 μm. In another embodiment, the adhesive layer has a thickness of from 0.1 μm, or 0.5 μm, or 1 μm to 1.5 μm, or 2 μm, or 3 μm, or 4 μm, or 5 μm, or 8 μm, or 10 μm.

In an embodiment, the adhesive layer has a substantially uniform thickness from each edge surface to the opposing edge surface. In an adhesive layer having substantially uniform thickness from each edge surface to the opposing edge surface, the top surface and the opposing bottom surface extend parallel to each other.

The adhesive layer may comprise two or more embodiments disclosed herein.

The adhesive layer may comprise two or more embodiments disclosed herein.

### K. Optional Metal-Detectable Layer

In some embodiments, the coated label includes (A) a polymeric substrate having a top surface and an opposing bottom surface; (B) a metal-detectable layer having a top surface and an opposing bottom surface, the metal-detectable layer in contact with the bottom surface of the polymeric substrate; (C) an adhesive layer in contact with the bottom surface of the metal-detectable layer; and (D) a coating layer in contact with the top surface of the polymeric substrate, the coating layer formed from a coating composition containing (i) a resin having a hydroxyl number of at least 2; (ii) a pigment; (iii) a crosslinking agent comprising an isocyanate prepolymer; and (iv) a solvent.

The coating composition, the resin, the pigment, the crosslinking agent, and the solvent may be any coating composition, resin, pigment, crosslinking agent, and solvent disclosed herein.

In some embodiments, the coated label includes € an optional release liner in contact with the adhesive layer.

In an embodiment, the metal-detectable layer includes a metal-detectable component, such as stainless steel. In some embodiments, the metal-detectable layer is formed from a metal-detectable composition containing a metal detectable-component.

In an embodiment, the metal-detectable composition contains (i) a metal detectable-component and (ii) a resin. In a further embodiment, the metal-detectable composition contains (i) a metal-detectable component, (ii) a resin, (iii) solvent, and (iv) a crosslinking agent. A nonlimiting example of a suitable resin is amorphous polyester resin (e.g., VYLON 270, available from Toyobo MC Corporation). A nonlimiting example of a suitable crosslinking agent is an aromatic polyisocyanate (e.g., Desmodur L 67 MPA/X). The solvent may be any solvent disclosed herein. Nonlimiting examples of suitable metal-detectable components are a stainless steel powders (e.g., PolyMag Gray HSNY, PolyMag Gray HSCP, PolyMag Gray HSPC, PolyMag Gray HSPP, and PolyMag Gray HSU-ET, each available from Eriez Manufacturing Co.) and barium sulfate powders (e.g., PolyMag Beige XRD, available from Eriez Manufacturing Co.).

In some embodiments, the metal-detectable composition contains at least 25 wt %, or at least 30 wt %, or at least 35 wt %, or at least 40 wt % of the metal-detectable component, based on the total weight of the metal-detectable composition. In another embodiment, the metal-detectable composition contains from 25 wt % to 75 wt %, or from 30 wt % to 60 wt %, or from 40 wt % to 50 wt % of the metal-detectable component, based on the total weight of the metal-detectable composition.

The metal-detectable composition may be prepared by mixing the (i) a metal-detectable component, (ii) a resin, and (iii) solvent to form a composition, and then mixing the (iv) crosslinking agent with the composition under reactive conditions to form the metal-detectable composition.

In an embodiment, the metal-detectable composition is a crosslinked metal-detectable composition.

In an embodiment, the metal-detectable layer (after drying) has a dry coating weight of from 75 pounds/ream (lb/rm) to 100 lb/rm, or from 75 lb/rm to 95 lb/rm, or from 78 lb/rm to 92 lb/rm.

In an embodiment, the metal-detectable layer has a thickness of from 20 μm to 100 μm, or from 20 μm to 75 μm, or from 20 μm to 60 μm, or from 25 μm to 55 μm, or from 25.4 μm to 50.8 μm. In another embodiment, the metal-detectable layer has a thickness of from 20 μm, or 25 μm, or 25.4 μm to 50.8 μm, or 55 μm, or 60 μm, or 75 μm, or 100 μm.

In an embodiment, the metal-detectable layer has a substantially uniform thickness from each edge surface to the opposing edge surface. In a metal-detectable layer having substantially uniform thickness from each edge surface to the opposing edge surface, the top surface and the opposing bottom surface extend parallel to each other.

The metal-detectable layer may directly or indirectly contact the polymeric substrate. In an embodiment, the metal-detectable layer indirectly contacts the polymeric substrate. In another embodiment, the metal-detectable layer directly contacts the polymeric substrate.

The metal-detectable layer may directly or indirectly contact the adhesive layer. In an embodiment, the metal-detectable layer indirectly contacts the adhesive layer. In another embodiment, the metal-detectable layer directly contacts the adhesive layer.

The metal-detectable layer may comprise two or more embodiments disclosed herein.

### L. Optional Release Liner

In some embodiments, the coated label includes an optional release liner in contact with the adhesive layer.

Nonlimiting examples of release liners include glassine paper, laminated paper, differential release liner, polyester film, and polypropylene film, each of which may or may not have been subjected to a coating of silicone.

In an embodiment, the release liner is a polyester self-wound differential release liner.

In one embodiment the coated label is void of a release liner. In this embodiment the release liner may or may not be replaced with a release coating, e.g., a silicone-based or wax-based material.

The release liner is removed from the coated label before it is applied to an end-use surface.

The release liner has atop surface and an opposing bottom surface.

In an embodiment, the release liner has a thickness of from 10 μm to 400 μm, or from 50 μm to 300 μm, or from 100 μm to 200 μm.

The optional release liner may comprise two or more embodiments disclosed herein.

In an embodiment, the coated label includes (A) the polymeric substrate having a top surface and an opposing bottom surface; (B) the adhesive layer in contact with the bottom surface of the polymeric substrate; and (C) the coating layer in contact with the top surface of the polymeric substrate. In a further embodiment, the coated label has the following Structure I:

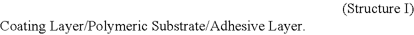

FIG. 2 is a schematic of a coated label having the Structure I. The coated label 10 has a coating layer 12, a polymeric substrate 14, and an adhesive layer 16. The coating layer 12 directly contacts the polymeric substrate 14. Further, the polymeric substrate 14 directly contacts the adhesive layer 16. However, it is understood that in an alternate embodiment, one or more of the layers of Structure I may instead indirectly contact an adjacent layer.

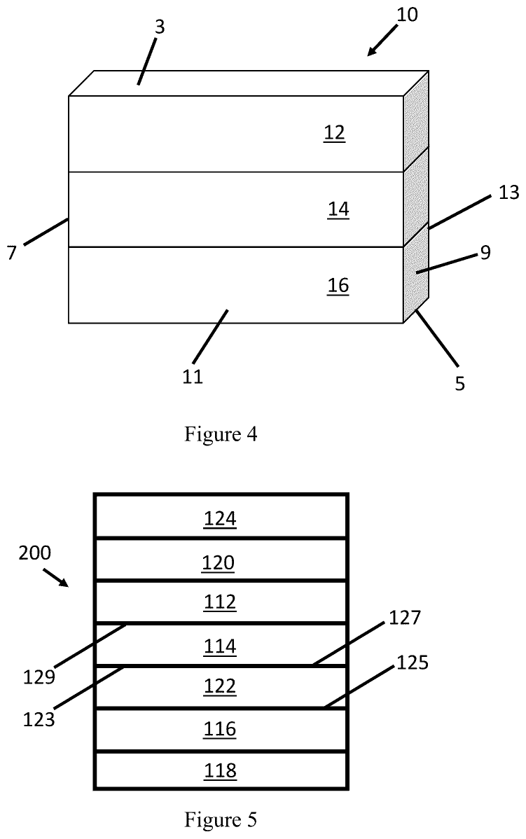

In an embodiment, as shown in FIG. 4, the coated label 10 has a top facial surface 3 and an opposing bottom facial surface 5. The coated label 10 has a front edge surface 7 and an opposing rear edge surface 9. The coated label 10 has a left edge surface 11 and an opposing right edge surface 13. A layer that has substantially uniform thickness has substantially the same thickness extending from the front edge surface 7 to the opposing rear edge surface 9, and from the left edge surface 11 to the opposing right edge surface 13.

In some embodiments, the coated label includes (A) a polymeric substrate having a top surface and an opposing bottom surface; (B) an adhesive layer in contact with the bottom surface of the polymeric substrate; (C) a coating layer in contact with the top surface of the polymeric substrate; and (D) the release liner in contact with the adhesive layer. In a further embodiment, the coated label has the following Structure II:

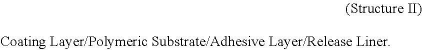

In some embodiments, the coated label includes (A) a polymeric substrate having a top surface and an opposing bottom surface; (B) a metal-detectable layer having a top surface and an opposing bottom surface, the top surface of the metal-detectable layer in contact with the bottom surface of the polymeric substrate; (C) an adhesive layer in contact with the bottom surface of the metal-detectable layer; (D) a coating layer in contact with the top surface of the polymeric substrate; and (D) the release liner in contact with the adhesive layer. In a further embodiment, the coated label has the following Structure III:

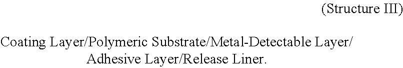

The polymeric substrate may be formed by extrusion. Optional additives in polymeric substrate (such as pigments) may be added during compounding prior to extrusion, or they may be added inline during extrusion. The polymeric substrate is a film. The film may be a single layer film or a multilayer film. In an embodiment, the polymeric substrate is a single layer film. In another embodiment, the polymeric substrate is a multilayer film, with at least one layer containing a polymer.

In some embodiments, the metal-detectable composition is applied to the bottom surface of the polymeric substrate via slot die coating. The coated metal-detectable composition is then exposed to heat and convective air movement to remove, or substantially remove, solvent and/or water that may be present in the metal-detectable composition to form the metal-detectable layer. The slot die coating and heat/air movement exposure steps may be repeated until the desired thickness of the metal-detectable layer is attained.

In some embodiments, the adhesive layer is applied to the bottom surface of the polymeric substrate (or the metal-detectable layer) via slot die coating. The coated adhesive layer is then exposed to heat and convective air movement to remove, or substantially remove, solvent and/or water that may be present in the PSA. The slot die coating and heat/air movement exposure steps may be repeated until the desired thickness of the adhesive layer is attained.

In some embodiments, the adhesive layer is hot-melt coated on the bottom surface of the polymeric substrate (or the metal-detectable layer). During hot-melt coating, the PSA is placed in a drum unloader, in which the PSA is heated to a target temperature. The PSA is then pumped to a melt tank with a controlled temperature and volume level. A coating head pumps the PSA from the melt tank at a constant rate to maintain a constant layer thickness. The coated adhesive layer is then cooled to room temperature.

The coating compositions, and further the crosslinked coating compositions, prepared as described above may be applied to the polymeric substrate, or further, the top surface of the polymeric substrate. For example, the coating composition may be applied to the top surface of the polymeric substrate with applicator rods, via #70 Mayer rod, knife over roll coating, or slot die coating. The coating layer contacts the top surface of the polymeric substrate and the polymeric substrate contacts the adhesive layer. The coated label is then exposed to heat and convective air movement to remove, or substantially remove, solvent and/or water that may be present in the coating layer.

In an embodiment, a sheet is formed as described above. Then, the sheet is sliced or die cut into strips or the desired shape, such as a circle, a square, or a rectangle, to form the coated labels. In some embodiments, the strip is wound onto itself to form a roll. In some embodiments, a continuous sheet or strip of release liner contains a plurality of coated labels, wherein each coated label may or may not be in contact with an adjacent coated label.

In an embodiment, the coated label (after drying) has a total thickness of from 175 μm (6.88 mil) to 197 μm (7.75 mil), or from 180 μm to 190 μm, or is 188 μm. It is understood that the total thickness of the coated label (after drying) excludes the thickness of the optional release liner. In other words, the total thickness of the coated label (after drying) is the cumulative thickness of the optional ink layer (described below), the optional mordant layer (described below) the coating layer, the polymeric substrate, and the adhesive layer (and any intermediate layer between the aforesaid layers), but excluding the thickness of the release liner.

It is understood that during drying, all or substantially all of the solvent present in the coating layer is removed.

The present disclosure provides a method of forming a coated label. The method includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to a top surface of a polymeric substrate to form a coated substrate; (D) drying the coated substrate to form a dried coated substrate; and € applying an adhesive layer to a bottom surface of the polymeric substrate to form a coated label.

In another embodiment, the method includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to a top surface of a polymeric substrate to form a coated substrate; (D) drying the coated substrate to form a dried coated substrate; (E) applying a metal-detectable composition to a bottom surface of the polymeric substrate to form a coated metal-detectable substrate; (F) drying the coated metal-detectable substrate to form a dried coated metal-detectable substrate having a metal-detectable layer; and (G) applying an adhesive layer to a bottom surface of the metal-detectable layer to form a coated label.

In an embodiment, the coated label has a substantially uniform thickness from each edge surface to the opposing edge surface. In a coated label having substantially uniform thickness from each edge surface to the opposing edge surface, the top surface and the opposing bottom surface extend parallel to each other.

### M. Optional Mordant Composition and Optional Mordant Layer

In some embodiments, the coated label is treated with a mordant composition.

In an embodiment, the mordant composition includes (i) a solvent, (ii) a mordant, and (iii) a surfactant. The solvent and the surfactant may be any solvent or surfactant disclosed herein. The solvent in the mordant composition may be the same or different than the solvent in the coating composition.

In an embodiment, the solvent is selected from n-butyl acetate, methyl n-amyl ketone, xylene, cyclohexanone, N-methyl-2-pyrrolidone (“NMP”), toluene, 1,3-dioxolane, methoxypropyl acetate, naptha, water (e.g., deionized water), and combinations thereof. In another embodiment, the solvent is water.

In an embodiment, the surfactant is polyether-modified polydimethylsiloxane (e.g., Byk-3455, available from Byk-Chemic GmbH).

The mordant is a metal salt. A nonlimiting example of a suitable mordant is anhydrous calcium chloride. Anhydrous calcium chloride has a solubility in water of 745 g/L at 20° C.

In some embodiments, the mordant has a solubility in water of at least 1 g/100 mL (10 g/L), or at least 100 g/L, or at least 300 g/L, or at least 500 g/L, or at least 700 g/L at 20° C. In another embodiment, the mordant has a solubility in water of from 10 g/L to 1,000 g/L, or from 500 g/L to 1,000 g/L, or from 700 g/L to 800 g/L at 20° C.

In an embodiment, the mordant composition contains from 90 wt % to 99.8 wt %, or from 95 wt % to 99.6 wt %, or from 99.0 wt % to 99.6 wt % solvent, based on the total weight of the mordant composition.

In an embodiment, the mordant composition contains from 0.1 wt % to 5 wt %, or from 0.1 wt % to 3 wt %, or from 0.1 wt % to 2 wt %, or from 0.1 wt % to 1 wt %, or from 0.1 wt % to 0.5 wt %, or from 0.1 wt % to 0.2 wt % surfactant, based on the total weight of the mordant composition.

In an embodiment, the mordant composition contains from 0.1 wt % to 5 wt %, or from 0.1 wt % to 3 wt %, or from 0.1 wt % to 2 wt %, or from 0.1 wt % to 1 wt %, or from 0.1 wt % to 0.5 wt %, or from 0.1 wt % to 0.25 wt % mordant, based on the total weight of the mordant composition.

In an embodiment, the mordant composition contains (A) from 90 wt % to 99.8 wt %, or from 95 wt % to 99.6 wt %, or from 99.0 wt % to 99.6 wt % solvent; (B) from 0.1 wt % to 5 wt %, or from 0.1 wt % to 3 wt %, or from 0.1 wt % to 2 wt %, or from 0.1 wt % to 1 wt %, or from 0.1 wt % to 0.5 wt %, or from 0.1 wt % to 0.2 wt % surfactant; and (C) from 0.1 wt % to 5 wt %, or from 0.1 wt % to 3 wt %, or from 0.1 wt % to 2 wt %, or from 0.1 wt % to 1 wt %, or from 0.1 wt % to 0.5 wt %, or from 0.1 wt % to 0.25 wt % mordant, based on the total weight of the mordant composition. The mordant composition may have one, some, or all of the following properties:
(i) the solvent is water; and/or
(ii) the surfactant is polyether-modified polydimethylsiloxane; and/or
(iii) the mordant is anhydrous calcium chloride; and/or
(iv) the mordant has a solubility in water of from 10 g/L to 1,000 g/L, or from 500 g/L to 1,000 g/L, or from 700 g/L to 800 g/L, or of 745 g/L at 20° C.

The mordant composition may be formed by combining the solvent, surfactant, and mordant in a container and mixing.

In an embodiment, the method of forming a coated label includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to atop surface of a polymeric substrate to form a coated substrate; (D) drying the coated substrate to form a dried coated substrate; € exposing the dried coated substrate to a mordant composition including a second solvent, a mordant, and a surfactant to form a mordant-treated coated substrate; (F) drying the mordant-treated coated substrate to form a dried mordant-treated coated substrate; and (G) applying an adhesive layer to a bottom surface of the polymeric substrate of the dried mordant-treated coated substrate to form a coated label.

In another embodiment, the method includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to a top surface of a polymeric substrate to form a coated substrate; (D) drying the coated substrate to form a dried coated substrate; € exposing the dried coated substrate to a mordant composition including a second solvent, a mordant, and a surfactant to form a mordant-treated coated substrate; (F) drying the mordant-treated coated substrate to form a dried mordant-treated coated substrate; (G) applying a metal-detectable composition to a bottom surface of the polymeric substrate to form a coated metal-detectable substrate; (H) drying the coated metal-detectable substrate to form a dried coated metal-detectable substrate having a metal-detectable layer; and (I) applying an adhesive layer to a bottom surface of the metal-detectable layer to form a coated label.

In some embodiments, the step of exposing the dried coated substrate to the mordant composition incudes immersing the dried coated substrate in the mordant composition for a period of time, and then, after removing the mordant-treated coated substrate from the mordant composition, metering off the excess mordant composition with a #10 Gardco rod. The mordant-treated coated substrate is then exposed to heat and convective air movement to remove, or substantially remove, solvent and/or water that may be present in the mordant layer.

The mordant treatment forms a mordant layer in direct contact with the top surface of the coating layer. While the mordant layer has a thickness, it is understood that the thickness of the mordant layer is negligible.

After being treated with the mordant composition, the adhesive layer may be applied to the bottom surface of the polymeric substrate of the dried mordant-treated coated substrate for form a coated label.

In another embodiment, after being treated with the mordant composition, the metal-detectable layer may be formed on the bottom surface of the polymeric substrate of the dried mordant-treated coated substrate. Then, the adhesive layer may be applied to the bottom surface of the metal-detectable layer to form a coated label.

The adhesive layer (and optional release liner) may be applied first, forming an adhesive layer/release liner structure, and then laminating the adhesive layer/release liner structure to the bottom surface of the dried mordant-treated coated substrate, such that the adhesive layer contacts the polymeric substrate (or the metal-detectable layer).

In some embodiments, the coated label includes (A) a polymeric substrate having atop surface and an opposing bottom surface; (B) an adhesive layer in contact with the bottom surface of the polymeric substrate; (C) a coating layer in contact with the top surface of the polymeric substrate; (D) a mordant layer in contact with a top surface of the coating layer; and (D) the release liner in contact with the adhesive layer. In a further embodiment, the coated label has the following Structure IV:

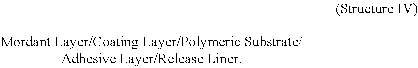

In some embodiments, the coated label includes (A) a polymeric substrate having atop surface and an opposing bottom surface; (B) a metal-detectable layer having a top surface and an opposing bottom surface, the top surface of the metal-detectable layer in contact with the bottom surface of the polymeric substrate, (C) an adhesive layer in contact with the bottom surface of the metal-detectable layer; (D) a coating layer in contact with the top surface of the polymeric substrate; € a mordant layer in contact with a top surface of the coating layer; and (F) the release liner in contact with the adhesive layer. In a further embodiment, the coated label has the following Structure V:

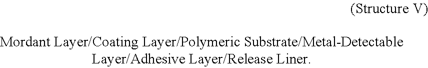

In Structure IV and Structure V, the mordant layer is the top facial surface of the coated label. In other words, the top surface of the coated label structure is the top facial surface of the mordant layer. The mordant layer is therefore exposed to ambient environment. Structure IV is depicted in FIG. 3.

FIG. 3 is a schematic of a coated label having the Structure IV. The coated label 100 has a mordant layer 120, a coating layer 112, a polymeric substrate 114, an adhesive layer 116, and a release liner 118. The mordant layer 120 directly contacts the coating layer 112. The coating layer directly contacts the polymeric substrate 114. The polymeric substrate 114 directly contacts the adhesive layer 116. The adhesive layer 116 directly contacts the release liner 118. It is understood that in an alternate embodiment, one or more of the layers of Structure IV may instead indirectly contact an adjacent layer. While the mordant layer 120 is depicted as a distinct layer, it is understood that a portion of, substantially all, or all, of the mordant layer 120 may be absorbed into the coating layer 112.

The mordant may comprise two or more embodiments disclosed herein.

The mordant composition may comprise two or more embodiments disclosed herein.

The coated label may comprise two or more embodiments disclosed herein.

### N. Printed Coated Label

In some embodiments, the coated label is printable.

A “printable” coated label is a label that is configured to run through a printing machine in its normal operation, and receive and retain ink on or in the coating layer. To constitute a printable coated label, the coated label must have a structure that is capable of being run through a printing machine (e.g., having an appropriate thickness). Further, the coated label's top facial surface (here, the top surface of the coating layer or the top facial surface of the mordant layer) should be smooth, or substantially smooth, so as to avoid uneven printing or voids in printing. Moreover, in some embodiments, the coated label should have a substantially uniform thickness from each edge surface to the opposing edge surface.

In some embodiments, the coated label is printed with an inkjet ink. The inkjet ink is applied to the coated label's top facial surface in an inkjet printer. Not wishing to be bound by any particular theory, it is believed that at least a portion of the inkjet ink is absorbed by the coating layer.

It is understood that some or all of the ink may be absorbed by the coating layer, or the ink may form a discrete layer having a top surface and an opposing bottom surface, the bottom surface contacting the coated label's top facial surface (i.e., the top surface of the coating layer or the mordant layer). Regardless of whether the ink is absorbed by the coating layer (partially or completely), the ink deposited by the printer onto the coating layer is herein be referred to as an “ink layer.”

In an embodiment, the ink layer is formed from inkjet ink. Nonlimiting examples of suitable inkjet ink include the ink colors cyan, magenta, yellow, and black.

A nonlimiting example of a suitable inkjet printer is a BradyJet J2000 Color Label Printer, available from Brady Corporation. A nonlimiting example of a suitable ink is the BradyJet J2000 Full Color Ink Cartridge (part number J20-CMY).

The ink layer may directly or indirectly contact the coating layer. In an embodiment, the ink layer directly contacts the coating layer.

In an embodiment, the ink layer is in the form of a graphic image, such as a pattern (e.g., striped, dotted, etc.), indicia, text, or a combination thereof. For example, the graphic image may be text that says “BIOHAZARD” and the coated label may be placed on an end-use surface, such as a vial, to indicate that the contents of the vial are biohazardous. In another instance, the graphic image may be the image of a triangle shape with an exclamation point therein and the coated label may be used on an end-use surface, such as a drum, to indicate that the drum contains dangerous materials.

In an embodiment, the method of forming a printed coated label includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to atop surface of a polymeric substrate to form a coated substrate; (D) drying the coated substrate to form a dried coated substrate; € exposing the dried coated substrate to a mordant composition including a second solvent, a mordant, and a surfactant to form a mordant-treated coated substrate; (F) drying the mordant-treated coated substrate to form a dried mordant-treated coated substrate; (G) applying an adhesive layer to a bottom surface of the polymeric substrate of the dried mordant-treated coated substrate to form a coated label; and (H) inkjet printing an ink layer onto a top surface of the coated label to form a printed coated label.

In another embodiment, the method includes (A) mixing a resin having a hydroxyl number of at least 2, a pigment, a first solvent, and a dispersant to form a composition; (B) mixing a crosslinking agent including an isocyanate prepolymer with the composition under reactive conditions to form a coating composition; (C) applying the coating composition to a top surface of a polymeric substrate to form a coated substrate; (D) drying the coated substrate to form a dried coated substrate; € exposing the dried coated substrate to a mordant composition including a second solvent, a mordant, and a surfactant to form a mordant-treated coated substrate; (F) drying the mordant-treated coated substrate to form a dried mordant-treated coated substrate; (G) applying a metal-detectable composition to a bottom surface of the polymeric substrate to form a coated metal-detectable substrate; (H) drying the coated metal-detectable substrate to form a dried coated metal-detectable substrate having a metal-detectable layer; (I) applying an adhesive layer to a bottom surface of the metal-detectable layer to form a coated label; and (J) inkjet printing an ink layer onto a top surface of the coated label to form a printed coated label.

The ink layer may comprise two or more embodiments disclosed herein.

In an embodiment, the printed coated label includes (A) the polymeric substrate having a top surface and an opposing bottom surface; (B) the adhesive layer in contact with the bottom surface of the polymeric substrate; (C) the coating layer in contact with the top surface of the polymeric substrate; and (D) an ink layer in contact with the coating layer. In a further embodiment, the printed coated label has the following Structure VI:

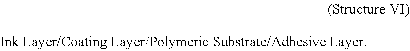

In some embodiments, the printed coated label includes (A) a polymeric substrate having atop surface and an opposing bottom surface; (B) an adhesive layer in contact with the bottom surface of the polymeric substrate; (C) the coating layer in contact with the top surface of the polymeric substrate; (D) the ink layer in contact with the coating layer; and € the release liner in contact with the adhesive layer. In a further embodiment, the printed coated label has the following Structure VII:

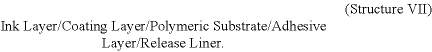

In an embodiment, the printed coated label includes (A) the polymeric substrate having a top surface and an opposing bottom surface; (B) the adhesive layer in contact with the bottom surface of the polymeric substrate; (C) the coating layer in contact with the top surface of the polymeric substrate; (D) a mordant layer in contact with a top surface of the coating layer; and € an ink layer in contact with the mordant layer. In a further embodiment, the printed coated label has the following Structure VIII:

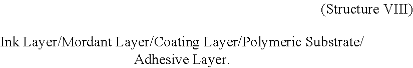

In some embodiments, the printed coated label includes (A) a polymeric substrate having atop surface and an opposing bottom surface; (B) an adhesive layer in contact with the bottom surface of the polymeric substrate; (C) the coating layer in contact with the top surface of the polymeric substrate; (D) a mordant layer in contact with a top surface of the coating layer; (D) the ink layer in contact with the mordant layer; and € the release liner in contact with the adhesive layer. In a further embodiment, the printed coated label has the following Structure IX:

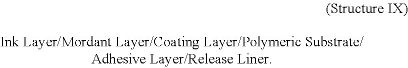

It is understood that any of the above Structures VI-IX may or may not include a metal-detectable layer. In an embodiment, in any one of Structures VI-IX, a metal-detectable layer is present between the polymeric substrate and the adhesive layer, such that the top surface of the metal-detectable layer contacts the polymeric substrate and the bottom surface of the metal-detectable layer contacts the adhesive layer. For example, FIG. 5 is a schematic of a coated label having the Structure IX, but including a metal-detectable layer. The coated label 200 has an ink layer 124, a mordant layer 120, a coating layer 112, a polymeric substrate 114, a metal-detectable layer 122, an adhesive layer 116, and a release liner 118. The ink layer 124 directly contacts the mordant layer 120. The mordant layer 120 directly contacts the coating layer 112. The coating layer directly contacts the top surface 129 of the polymeric substrate 114. The bottom surface 127 of the polymeric substrate 114 directly contacts the top surface 123 of the metal-detectable layer 122. The bottom surface 125 of the metal-detectable layer 122 directly contacts the adhesive layer 116. The adhesive layer 116 directly contacts the release liner 118. It is understood that in an alternate embodiment, one or more of the layers of Structure IV may instead indirectly contact an adjacent layer. While the mordant layer 120 is depicted as a distinct layer, it is understood that a portion of, substantially all, or all, of the mordant layer 120 may be absorbed into the coating layer 112. Further, while the ink layer 124 is depicted as a distinct layer, it is understood that a portion of, substantially all, or all, of the ink layer 124 may be absorbed into the mordant layer 120 and/or the coating layer 112.

In an embodiment, the printed coated label (after drying) has a total thickness of from 50 μm to 500 μm, or from 50 μm to 300 μm, or from 50 μm to 200 μm, or from 50 μm to 150 μm. In another embodiment, the coated label (after drying) has a thickness of from 50 μm, or 75 μm, or 100 μm to 150 μm, or 200 μm, or 300 μm, or 400 μm, or 500 μm. It is understood that the total thickness of the printed coated label (after drying) excludes the thickness of the optional release liner. In other words, the total thickness of the printed coated label (after drying) is the cumulative thickness of the ink layer (described below), the optional mordant layer, the coating layer, the polymeric substrate, and the adhesive layer (and any intermediate layer between the aforesaid layers), but excluding the thickness of the release liner.

It is understood that during drying, all or substantially all of the solvent present in the coating layer, mordant layer, and ink layer is removed.

In an embodiment, the printed coated label is an inkjet printed coated label having an ink layer containing inkjet ink.

In an embodiment, the printed coated label is an inkjet printed coated label having an ink layer containing inkjet ink. In an embodiment, the printed coated label has a cyan color density of at least 0.56, or at least 0.57, or at least 0.62, or at least 0.75, or at least 0.86.

In an embodiment, the printed coated label is an inkjet printed coated label having an ink layer containing inkjet ink. In an embodiment, the printed coated label has a magenta color density of at least 0.70, or at least 0.71, or at least 7.20, or at least 0.76, or at least 90, or at least 95.

In an embodiment, the printed coated label is an inkjet printed coated label having an ink layer containing inkjet ink. In an embodiment, the printed coated label has a yellow color density of at least 0.75, or at least 0.80, or at least 0.81, or at least 0.82, or at least 0.90, or at least 0.94, or at least 0.98.

In an embodiment, the printed coated label is an inkjet printed coated label having an ink layer containing inkjet ink. In an embodiment, the printed coated label has a black color density of at least 0.70, or at least 0.71, or at least 0.75, or at least 0.82, or at least 0.83, or at least 0.96.

In an embodiment, the printed coated label is an inkjet printed coated label having an ink layer containing inkjet ink. In an embodiment, the printed coated label has one, some, or all of the following properties:
(i) a cyan color density of at least 0.56, or at least 0.57, or at least 0.62, or at least 0.75, or at least 0.86; and/or
(ii) a magenta color density of at least 0.70, or at least 0.71, or at least 7.20, or at least 0.76, or at least 90, or at least 95; and/or
(iii) a yellow color density of at least 0.75, or at least 0.80, or at least 0.81, or at least 0.82, or at least 0.90, or at least 0.94, or at least 0.98; and/or
(iv) a black color density of at least 0.70, or at least 0.71, or at least 0.75, or at least 0.82, or at least 0.83, or at least 0.9.

In an embodiment, the printed coated label is an inkjet printed coated label having an ink layer containing inkjet ink. In an embodiment, the printed coated label has a dry time of up to 60 seconds, or up to 30 seconds. In another embodiment, the printed coated label has a dry time of 30 seconds or less.

In an embodiment, the printed coated label is an inkjet printed coated label having an ink layer containing inkjet ink. In an embodiment, the printed coated label exhibits no visible change after harsh wash (1,000 psi; 70° C. water; distance of 12 inches; water flow of 4 gal/min; 30 second spray at horizontal angle to label top surface). “No visible change” means that the ink layer has not faded and there is no chipping or removal of the coating layer.

In an embodiment, the printed coated label is an inkjet printed coated label having an ink layer containing inkjet ink. In an embodiment, the printed coated label exhibits no bleed.

In an embodiment, the printed coated label is an inkjet printed coated label having an ink layer containing inkjet ink. In an embodiment, the printed coated label exhibits no visible change after abrasion resistance testing. “No visible change” means that there is no observable scratching to the top facial surface of the printed coated label and there is no chipping or removal of the coating layer.

In an embodiment, the printed coated label is an inkjet printed coated label having an ink layer containing inkjet ink. In a further embodiment, after one day of aging, the ink layer is able to withstand at least 50 rubs with methyl ethyl ketone before the ink layer is broken through.

In an embodiment, the printed coated label is an inkjet printed coated label having an ink layer containing inkjet ink. In a further embodiment, the printed coated label has one, some, or all of the following properties:
(i) a dry time of up to 60 seconds, or up to 30 seconds; and/or
(ii) no visible change after harsh wash (1,000 psi; 70° C. water; distance of 12 inches; water flow of 4 gal/min; 30 second spray at horizontal angle to label top surface); and/or
(iii) no bleed; and/or
(iv) no visible change after abrasion resistance testing; and/or
(v) able to withstand at least 50 rubs with methyl ethyl ketone before the ink layer is broken through; and/or
(vi) a cyan color density of at least 0.56, or at least 0.57, or at least 0.62, or at least 0.75, or at least 0.86; and/or
(vii) a magenta color density of at least 0.70, or at least 0.71, or at least 7.20, or at least 0.76, or at least 90, or at least 95; and/or
(viii) a yellow color density of at least 0.75, or at least 0.80, or at least 0.81, or at least 0.82, or at least 0.90, or at least 0.94, or at least 0.98; and/or
(ix) a black color density of at least 0.70, or at least 0.71, or at least 0.75, or at least 0.82, or at least 0.83, or at least 0.9.

The present coated label, and further the printed coated label, are suitable for being applied to an end-use surface. Nonlimiting examples of suitable end-use surfaces include surfaces of food preparation equipment, jars, cans, containers, boxes, vials, beakers, flasks, tubes, graduated cylinders, petri dishes, bottles, drums, shelves, benches, and barrels. In some embodiments, the end-use surface is the surface of a piece of equipment used in the food and beverage industry. The end-use surface may be a glass surface, a plastic surface, a metal surface, a cardboard surface, a wood surface, or any other solid surface. The present coated label is suitable for both indoor and outdoor use.

The printed coated label may comprise two or more embodiments disclosed herein.

By way of example, and not limitation, examples of the present disclosure are provided.

### EXAMPLES

The materials used to produce the coating compositions and articles are provided in Table 1 below.

TABLE 1

| Component | Specification | Source |
|---|---|---|
| Anhydrous CaCl₂ | Anhydrous Calcium Chloride; Synthesis grade; | Sigma-Aldrich Inc. |
| | mordant | |
| Byk 3455 | Surfactant; wetting and leveling agent composed of a | Byk USA Inc. |
| | polyether-modified polydimethylsiloxane; solids | |
| | content = >90 wt % | |
| Byk-333 | Surfactant; polyether-modified polydimethylsiloxane | Byk USA Inc. |
| Byk-A 530 | Defoaming Agent; solution of foam-destroying | Byk USA Inc. |
| | polymers and polysiloxanes; solvents = hydrocarbon | |
| | mixture | |
| n-Butyl Acetate | urethane grade solvent | CQ Chemicals |
| | | Corporation |
| Methyl n-amyl | urethane grade solvent | Univar Solutions |
| ketone | | USA, Inc. |
| Xylene | solvent | Nexeo Solutions |
| | | LLC |
| Cyclohexanone | solvent | Producers Chemical |
| | | Company |
| NMP | solvent; N-methyl-2-pyrrolidone | Brenntag Great |
| | | Lakes |
| Toluene | solvent | |
| DI Water | Reverse osmosis deionized water; solvent | |
| Desmophen 670 | Polyester resin; branched polyester polyol; solids | Covestro LLC |
| BA | content = 80 wt %; hydroxyl number = 3.5; a | |
| | number-average molecular weight = 1,600 g/mol; | |
| | supplied in n-butyl acetate | |
| Adcote 3840D | Polyester resin; high-molecular weight polyester resin; | Dow Chemical |
| | hydroxyl number = 10; supplied as 40% solids in | Company |
| | 1,3-dioxolane | |
| Phenoxy PK HH | Phenoxy resin; molecular weight = 52,000 g/mol; | Huntsman Advanced |
| | hydroxyl number = 200; supplied as 100% solids | Materials |
| | pellets | |
| Chempol 317- | Acrylic Polyol Resin; high-solids acrylic polyol; | Arkema Coating |
| 3867 | hydroxyl number = 95; supplied as 80 wt % solids | Resins |
| | in methyl n-amyl ketone | |
| Chempol 809- | High Solids Short Oil Alkyd Resin; air dry/force chain | Arkema Coating |
| 2837 | stopped tall oil fatty acid (“TOFA”) alkyd; hydroxyl | Resins |
| | number = 87; supplied as 75 wt % solids in butyl acetate | |
| Disperbyk-2164 | Dispersant; wetting and dispersing additive composed | Byk USA Inc. |
| | of a solution of modified polyurethane; solids content = | |
| | 60 wt %; supplied in butyl acetate/methoxypropyl | |
| | acetate 2:3 | |
| Lo-vel 6000 | Pigment; synthetic amorphous silicon dioxide; mean | PPG Industries, Inc. |
| | particle size = 9.5 micrometers; oil absorption | |
| | number = 270 mL oil/100 g pigment | |
| Syloid C-805 | Pigment; synthetic amorphous silicon dioxide; mean | W. R. Grace & Co. |
| | particle size = 5 micrometers; oil absorption | |
| | number = 315 g oil/100 g pigment | |
| Acematt OK 412 | Pigment; synthetic amorphous silicon dioxide; mean | Evonik Resource |
| | particle size = 6.3 micrometers; oil absorption | Efficiency GmbH |
| | number = 240 mL oil/100 g pigment | |
| Albacar 5970 | Pigment; precipitated calcium carbonate; mean particle | Specialty Minerals |
| | size = 1 micron; oil absorption = 50 grams | Inc. |
| | oil/100 grams pigment | |
| Tint-AYD ST | Pigment; rutile titanium dioxide dispersion; solids | Chromaflo |
| 8003 | content = 80 wt % | Technologies |
| | | Corporation |
| Martinal OL-107 | Pigment; finely-precipitated aluminum hydroxide | Huber Engineered |
| | | Materials |
| Dabco T-12 | Catalyst; dibutyltin dilaurate; solids content = 100 wt % | Evonik, Inc. |
| Desmodur N75 | Crosslinking agent; isocyanate prepolymer; aliphatic | Covestro LLC |
| BA/X | polyisocyanate (HDI biuret); solids content = 75 wt %; | |
| | NCO content = 16.5%; supplied in butyl acetate/xylene | |
| Desmodur N330 | Crosslinking agent; isocyanate prepolymer; aliphatic | Covestro LLC |
| BA/SN | polyisocyanate (HDI trimer); solids content = 90 wt %; | |
| | NCO content = 19.6%; supplied in butyl | |
| | acetate/solvent naptha | |
| Desmodur L 67 | Crosslinking agent; aromatic polyisocyanate based on | Covestro LLC |
| MPA/X | toluene diisocyanate; solids content = 67 wt %; NCO | |
| | content = 11.9%; supplied in 1-methoxypropylacetate- | |
| | 2/xylene (1:1) | |
| Additive OF | Moisture Scavenger | Borchers |
| Melinex 329 | opaque, white, non-pretreated polyester film; | DuPont Teijin Films |
| | polymeric substrate; thickness = 5 mil | |
| Release Liner | Polyester self-wound differential release liner; | Loparex |
| | thickness = 2 mil | |
| PSA | Rubber-acrylic pressure-sensitive adhesive (PSA) | Brady Corp. |
| B-2569 | Label stock; aqueous inkjet printable PET film with | Brady Corp. |
| | permanent PSA; polyester film with acrylic PSA; total | |
| | thickness (excluding liner) = 0.1194 mm | |
| B-2595 | Label stock; aqueous inkjet printable vinyl film with | Brady Corp. |
| | permanent acrylic PSA; vinyl film with acrylic PSA; | |
| | total thickness (excluding liner) = 0.1346 mm) | |
| B-7425J | Label stock; inkjet printable polypropylene with | Brady Corp. |
| | permanent acrylic PSA; polypropylene film with | |
| | acrylic PSA | |
| 7850-IJ | Label stock; inkjet printable matte white polyester film | 3M |
| | with adhesive; total thickness = 0.14961 inch | |
| Raflatac SY823Z | Label stock; inkjet printable vinyl film with adhesive | UPM Raflatac |

### 1. Preparation of Release Liner/Adhesive Layer Structure

The rubber-acrylic PSA (from Brady Corp.) is cast onto the release liner (from Loparex) and thermally cured. A release liner/adhesive layer structure is formed to have a 1-mil thick layer of rubber-acrylic PSA in direct contact with the release liner. The adhesive layer is continuous and extends from one side edge of the release liner to the opposite side edge. The resulting structure has a total thickness of 3 mil.

### 2. Preparation of Coating Compositions

Example 1: A given amount of polyester resin (Desmophen 670 BA), solvent (n-butyl acetate and methyl n-amyl ketone), dispersant (Disperbyk-2164), and pigment (Syloid C-805 and Lo-vel 6000) were added to a container and mixed using an HSD (high shear disperser) targeting a tip speed of 7 to 10 m/s for thirty minutes. Then, a given amount of solvent (methyl n-amyl ketone and xylene), catalyst (Dabco T-12), and crosslinking agent (Desmodur N75 BA/X) were added to the mixture in the container and mixed using an HSD targeting a tip speed of 7 to 10 m/s for two minutes to form coating composition Example 1.

Example 2: A given amount of phenoxy resin (PKHH, 30 wt % in 1,3-dioxolane), solvent (cyclohexanone), dispersant (Disperbyk-2164), and pigment (Syloid C-805) were added to a container and mixed using an HSD targeting a tip speed of 7 to 10 m/s for thirty minutes. Then, a given amount of solvent (xylene), catalyst (Dabco T-12), and crosslinking agent (Desmodur N75 BA/X) were added to the mixture in the container and mixed using an HSD targeting a tip speed of 7 to 10 m/s for two minutes to form coating composition Example 2.

Example 3: A given amount of acrylic polyol resin (Chempol 317-3867), solvent (n-butyl acetate and methyl n-amyl ketone), dispersant (Disperbyk-2164), and pigment (Acematt OK 412 and Tint-AYD ST 8003) were added to a container and mixed using an HSD targeting a tip speed of 7 to 10 m/s for thirty minutes. Then, a given amount of solvent (methyl n-amyl ketone and xylene), catalyst (Dabco T-12), and crosslinking agent (Desmodur N75 BA/X) were added to the mixture in the container and mixed using an HSD targeting a tip speed of 7 to 10 m/s for two minutes to form coating composition Example 3.

Example 4: A given amount of short oil alkyd resin (Chempol 809-2837), solvent (n-butyl acetate and methyl n-amyl ketone), dispersant (Disperbyk-2164), and pigment (Martinal OL-107 and Lo-vel 6000) were added to a container and mixed using an HSD targeting a tip speed of 7 to 10 m/s for thirty minutes. Then, a given amount of solvent (methyl n-amyl ketone and xylene), catalyst (Dabco T-12), and crosslinking agent (Desmodur N3390 BA/SN) were added to the mixture in the container and mixed using an HSD targeting a tip speed of 7 to 10 m/s for two minutes to form coating composition Example 4.

Example 5: A given amount of polyester resin (Adcote 3840D), solvent (toluene and NMP), dispersant (Disperbyk-2164), and pigment (Syloid C-805 and Albacar 5970) were added to a container and mixed using an HSD targeting a tip speed of 7 to 10 m/s for thirty minutes. Then, a given amount of solvent (xylene), catalyst (Dabco T-12), and crosslinking agent (Desmodur N3390 BA/SN) were added to the mixture in the container and mixed using an HSD targeting a tip speed of 7 to 10 m/s for two minutes to form coating composition Example 5.

Example 6: A given amount of polyester resin (Desmophen 670 BA), solvent (n-butyl acetate and methyl n-amyl ketone), dispersant (Disperbyk-2164), surfactant (Byk-333), defoaming agent (Byk A-530), and pigment (Syloid C-805 and Lo-vel 6000) were added to a container to achieve 48 wt % solids, and mixed using an HSD targeting a tip speed of 7 to 10 m/s for thirty minutes. Then, a given amount of solvent (n-butyl acetate) and Additive OF were added and mixed using an HSD targeting a tip speed of 7 to 10 m/s to homogeneity. After three days, a given amount of solvent (xylene), catalyst (Dabco T-12) and crosslinking agent (Desmodur N75 BA/X) were added to the mixture in the container and mixed using an HSD targeting a tip speed of 7 to 10 m/s for two minutes to form coating composition Example 6.

Table 2 provides the formulation for each coating composition.

TABLE 2
Coating Compositions*

| | | EX 1 | EX 2 | EX 3 | EX 4 | EX 5 | EX 6 |
|---|---|---|---|---|---|---|---|
| Resin | Desmophen 670BA | 23.52 | — | — | — | — | 22.76 |
| | Adcote 3840D | — | — | — | — | 32.41 | — |
| | Phenoxy PK HH | — | 51.05 | — | — | — | — |
| | (30 wt % in 1,3- | | | | | | |
| | dioxolane) | | | | | | |
| | Chempol 317-3867 | — | — | 25.31 | — | — | — |
| | Chempol 809-2837 | — | — | — | 26.26 | — | — |
| Solvent | n-Butyl acetate | 34.61 | — | 10.60 | 10.80 | — | 23.87 |
| | methyl n-amyl | 15.23 | — | 33.89 | 34.53 | — | 23.87 |
| | ketone | | | | | | |
| | xylene | 1.79 | 1.08 | 1.79 | 1.75 | — | 1.71 |
| | cyclohexanone | — | 35.85 | — | — | — | — |
| | NMP | — | — | — | — | 31.19 | — |
| | toluene | — | — | — | — | 19.50 | — |
| Dispersant: Disperbyk-2164 | | 0.30 | 0.30 | 0.30 | 0.30 | 0.30 | 1.12 |
| Surfactant: Byk-333 | | — | — | — | — | — | 0.50 |
| Defoaming Agent: | | — | — | — | — | — | 0.32 |
| Byk A-530 | | | | | | | |
| Moisture Scavenger: | | — | — | — | — | — | 2.00 |
| Additive OF | | | | | | | |
| Pigment | Syloid C-805 | 4.69 | 8.88 | — | — | 4.69 | 4.50 |
| | Lo-vel 6000 | 7.03 | — | — | 12.82 | — | 6.74 |
| | Acematt OK 412 | — | — | 13.23 | — | — | — |
| | Albacar 5970 | — | — | | — | 8.43 | — |
| | Tint-AYD ST 8003 | — | — | 3.31 | — | — | — |
| | Martinal OL-107 | — | — | — | 4.27 | — | — |
| Catalyst | Dabco T-12 | 0.09 | 0.06 | 0.10 | 0.09 | 0.05 | 0.09 |
| Cross- | Desmodur | 12.75 | 2.78 | 11.47 | — | — | 12.51 |
| linking | N75 BA/X | | | | | | |
| Agent | Desmodur | — | — | — | 9.18 | 2.48 | |
| | N330 BA/SN | | | | | | |

*Amounts are listed in wt %, based on the total weight of the coating composition.

### 3. Preparation of Coated Film

The coating compositions EX 1 to EX 5 prepared as described above are drawn down using a #70 Mayer rod onto atop surface of the Melinex 329 film and baked, first at 150° F. for two minutes and again at 300° F. for five minutes, resulting in a dry coating weight of approximately 33 pounds/ream.

The coating composition EX 6 prepared as described above is applied by slot die onto a top surface of the Melinex 329 film and baked, first at 150° F. for two minutes and again at 400° F. for five minutes, resulting in a dry coating weight of approximately 33 pounds/ream.

### 4. Preparation of Mordant Compositions

Example M1: A given amount of solvent (reverse osmosis deionized water), surfactant (Byk 3455), and mordant (Anhydrous CaCl₂)) were combined in a container and mixed (at approximately 100 rpm) for two minutes to form mordant composition Example M1.

Table 3 provides the formulation for each mordant composition.

TABLE 3
Mordant Compositions*

| | | EX M1 |
|---|---|---|
| Solvent | DI Water | 99.55 |
| Surfactant | Byk 3455 | 0.20 |
| Mordant | Anhydrous CaCl₂ | 0.25 |

*Amounts are listed in wt %, based on the total weight of the mordant composition.

### 5. Preparation of Mordant-Treated Coated Film

The coated films prepared as described above are immersed for ten seconds in the Example M1 mordant composition, withdrawn, and the excess mordant composition is metered off with a #10 Gardco rod. The resulting sample is dried in an oven first at 150° F. for two minutes, and then again at 300° C. for one minute, to form mordant-treated coated films.

### 6. Application of Metal-Detectable Composition

A metal-detectable composition is formed by combining 14.41 wt % ethyl acetate, 14.41 wt % toluene, 7.19 wt % xylene, 21.16 wt % VYLON 270 amorphous polyester resin (from Toyobo MC Corporation), 42.31 wt % POLYMAG stainless steel powder (Eriez Manufacturing Co. item number 448171B), and 0.53 wt % Desmodur L 67 MPA/X (crosslinking agent).

The metal-detectable composition is coated via slot die onto a bottom surface of the Melinex 329 film of the mordant-treated coated film prepared as described above with EX 6 and baked in an oven, first at 120° F. for 36 seconds, then at 140° F. for 36 seconds, then at 210° F. for 36 seconds, and finally at 260° F. for 36 seconds, resulting in a stainless-steel (“SS”) layer with a dry coating weight of 85 lb/rm+/−7 lb/rm.

### 7. Preparation of Coated Labels

EX A-EX E: The Release Liner/Adhesive Layer Structure prepared as described above (2-mil release liner/1-mil rubber-acrylic PSA) is laminated by hand to the bottom surface (i.e., the un-coated film surface) of the mordant-treated coated films prepared as described above to form a coated label.

EX F: Rubber-acrylic PSA (from Brady Corp.) is applied to a top surface of the SS layer of the mordant-treated coated film containing an SS layer prepared as described above to form an adhesive layer having a thickness of 1-mil. A release liner (from Loparex) is laminated by hand to the bottom surface of the adhesive layer to form a coated label.

Table 4 provides the structure for each example coated label.

TABLE 4
Coated Labels*

| | EX A | EX B | EX C | EX D | EX E | EX F |
|---|---|---|---|---|---|---|
| Mordant | EX M1 | EX M1 | EX M1 | EX M1 | EX M1 | EX MI |
| Composition | | | | | | |
| (dried) | | | | | | |
| Coating | EX 1 | EX 2 | EX 3 | EX 4 | EX 5 | EX 6 |
| Composition | | | | | | |
| (dried) | | | | | | |
| Film | Melinex | Melinex | Melinex | Melinex | Melinex | Melinex |
| | 329 | 329 | 329 | 329 | 329 | 329 |
| Metal- | — | — | — | — | — | SS |
| Detectable | | | | | | |
| Layer | | | | | | |
| Adhesive Layer | PSA | PSA | PSA | PSA | PSA | PSA |
| Release Liner | Loparex | Loparex | Loparex | Loparex | Loparex | Loparex |

*In the example coated labels EX A-E of Table 4, the label as the structure Mordant Composition/Coating Composition/Film/Adhesive Layer/Release Liner. EX F of Table 4 has the structure Mordant Composition/Coating Composition/Film/Metal-Detectable Layer/Adhesive Layer/Release Liner.

Comparative Sample 1 (CS 1) is label stock B-2569.

Comparative Sample 2 (CS 2) is label stock B-2595.

Comparative Sample 3 (CS 3) is label stock B-7425J.

Comparative Sample 4 (CS 4) is label stock 7850-IJ.

Comparative Sample 5 (CS 5) is label stock Raflatac SY823Z.

### 8. Preparation of Printed Labels

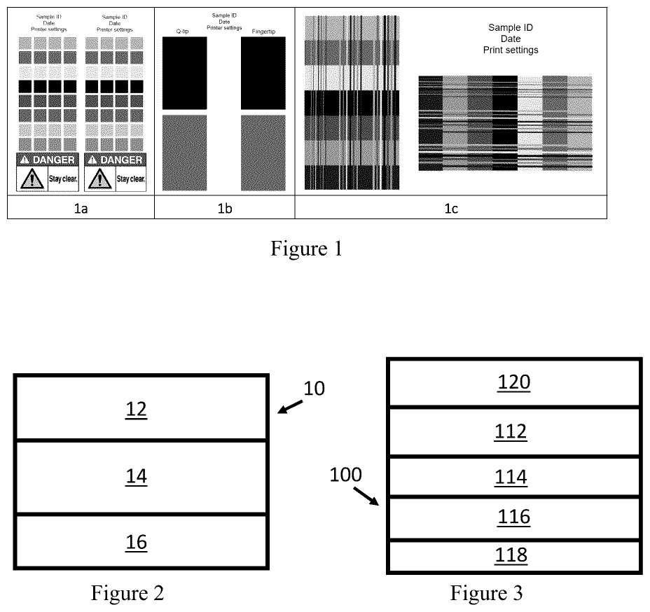

The coated labels EX A-EX E prepared as described above and the comparative sample labels CS 1-CS 5 were cut into 4×12 cm strips and fed into in a Bradylet J2000 printer with a J20-CMY full color ink cartridge (aqueous pigmented inkjet inks) from Brady Corporation set to print at 78% ink saturation, Quality Mode Q3, Best for Graphics. Each strip was printed with the template shown in FIG. 1 to form printed labels. In FIG. 1, 1a (left) shows the template used for Vibrancy, harsh wash, abrasion, and chemical resistance; 1b (middle) shows the template used for dry time; and 1c (right) shows the template used for bleed and print quality.

The printed labels are evaluated as described below.

Abrasion Resistance: Coated labels EX A-EX E prepared as described above and comparative sample labels CS 1-CS 5 are printed with template 1a shown in FIG. 1. About 24 hours after printing, the release liner is removed and the printed labels are hand-laminated to a stainless steel panel and placed in a Gardner Washability & Wear Tester Model D10. The laminated labels are placed under a thin layer of water and a 1 square-inch piece of a 3M “green scrubbie” cleaning pad is placed underneath the sled. A weight of 2 pounds is placed on top of the sled and the test is run for 100 cycles at an approximate rate of 75 cycles/minute. Each cycle represents one pass of the sled. Afterwards, the print degradation is qualitatively analyzed and compared to control samples, and scored. Control samples are run using B-855, a polyester label for harsh washdown environments available from Brady Corporation. A score of 1 indicates no visible effect; a score of 2 indicates minor scratching; a score of 3 indicates severe scratching; and a score of 4 indicates coating layer removal.

Chemical Resistance (Methyl Ethyl Ketone): Coated labels EX A-EX E prepared as described above and comparative sample labels CS 1-CS 5 are printed with template 1a shown in FIG. 1. Q-tips soaked in methyl ethyl ketone (“MEK”) are rubbed across all four columns of the top four rows (cyan, magenta, yellow, black) of the printed templates. The number of rubs until breakthrough are recorded (50 rubs maximum). “Breakthrough” is considered the number of rubs it takes before the coating composition is removed and the film is visible. Results are observed, recorded, and scored. A score of 1 indicates 50 or more rubs until breakthrough; a score of 2 indicates 20 to 49 rubs until breakthrough; a score of 3 indicates 10-20 rubs until breakthrough; and a score of 4 indicates less than 10 rubs until breakthrough.

Dry Time: Coated labels EX A-EX E prepared as described above and comparative sample labels CS 1-CS 5 are printed with template 1b shown in FIG. 1, with black boxes and colored boxes. After printing, the printed template is immediately rubbed three times forward and back with a Q-tip on one black square and one colored square, and rubbed with a finger with light-to-medium pressure on the other black square and the other colored square. This is repeated 10 seconds after printing, 20 seconds after printing, and 60 seconds after printing (unless instantly dry). Results are observed, recorded, and scored. A score of 1 indicates the printed template instantly dried after printing; a score of 2 indicates that the printed template dried within 0-30 seconds after printing; a score of 3 indicates the printed template dried within 31-59 seconds after printing; and a score of 4 indicates the printed template dried 60 seconds or more after printing.

Harsh Wash: Coated labels EX A-EX E prepared as described above and comparative sample labels CS 1-CS 5 are printed with template 1a shown in FIG. 1. About 24 hours after printing, the release liner is removed and the printed labels are hand-laminated to an aluminum panel that has been wiped with MEK. Three replicates are tested on each aluminum panel. The laminated samples dwell under ambient conditions for 24 hours. Laminated samples are then tested using a Karcher Professional HDS 4.0/20-4M Ea pressure washer. The water pressure is set to 1,000 psi using the appropriate nozzle. The water temperature is 70° C., the nozzle-to-sample distance is 12 inches, and the water flow rate is 4 gal/min. Samples are sprayed for 30 seconds from a horizontal angle, then observations are recorded and scored. A score of 1 indicates no visible effect; a score of 2 indicates ink fade; a score of 3 indicates coating layer chipping; and a score of 4 indicates coating layer removal.

Print Quality: Coated labels EX A-EX X prepared as described above and comparative sample labels CS 1-CS 5 are printed with template c shown in FIG. 1. The results are observed for bleed and scored. A score of 1 indicates no bleed; a score of 2 indicates minor bleed; a score of 3 indicates severe bleed; and a score of 4 indicates ink saturation.

Vibrancy: Coated labels EX A-EX E prepared as described above and comparative sample labels CS 1-CS 5 are printed with template 1a shown in FIG. 1. Color density and L*a*b* values are measured using the X-rite color densitometer about 24 hours after printing. All four columns/blocks of the top four rows (cyan, magenta, yellow, black) of the printed templates are tested, and the average is reported. While printing with CMY, color density represents the ink's ability to absorb light. Typically, a thicker ink layer will have a better ability to absorb light. However, a thicker ink layer requires the use of more materials and can therefore be more expensive to produce. Color density is a measurement of the color vibrancy. The more vibrant the color, the easier is to control color uniformity, and the easier it is for an individual to see what was printed. Consequently, it is advantageous for a printed label to achieve and maintain a high color density, even after exposure to certain conditions.

The results are reported below in Tables 5A and 5B.

TABLE 5A
Results*

| | | EX A | EX B | EX C | EX D | EX E | EX F |
|---|---|---|---|---|---|---|---|
| Abrasion Resistance | | 1 | 1 | 2 | 3 | 2 | 2 |
| Chemical Resistance | | 1 | 1 | 1 | 1 | 1 | 1 |
| Dry Time | | 1 | 1 | 1 | 4 | 1 | 2 |
| Harsh Wash | | 1 | 1 | 1 | 1 | 1 | 1 |
| Print Quality | | 1 | 1 | 1 | 1 | 1 | 1 |
| Vibrancy | C | 0.86 | 0.62 | 0.56 | 0.57 | 0.75 | 0.74 |
| | M | 0.95 | 0.72 | 0.71 | 0.76 | 0.90 | 0.97 |
| | Y | 0.98 | 0.82 | 0.81 | 0.90 | 0.94 | 0.94 |
| | K | 0.96 | 0.70 | 0.71 | 0.82 | 0.83 | 0.91 |

*Abrasion resistance, chemical resistance, dry time, harsh wash, and print quality are scored on a scale of 1-4, as described above.

TABLE 5B
Results*

| | | CS 1 | CS 2 | CS 3 | CS 4 | CS 5 |
|---|---|---|---|---|---|---|
| Abrasion Resistance | | 4 | 4 | 4 | 4 | 4 |
| Chemical Resistance | | 4 | 4 | 4 | 4 | 4 |
| Dry Time | | 1 | 1 | 1 | 2 | 2 |
| Harsh Wash | | 4 | 4 | 4 | 4 | 4 |
| Print Quality | | 1 | 1 | 1 | 1 | 1 |
| Vibrancy | C | 0.55 | 0.64 | 0.56 | 0.71 | 0.76 |
| | M | 0.74 | 0.80 | 0.75 | 0.83 | 0.84 |
| | Y | 0.75 | 0.80 | 0.79 | 0.79 | 0.88 |
| | K | 0.85 | 0.83 | 0.92 | 1.04 | 0.96 |

*Abrasion resistance, chemical resistance, dry time, harsh wash, and print quality are scored on a scale of 1-4, as described above.

As shown in Tables 5A and 5B, printed coated labels EX A-EX F each exhibits better abrasion resistance and harsh wash results compared to comparative samples CS 1-CS 5. The results indicate that EX A-EX F each is suitable for use in food and beverage applications, where the printed labels are likely to be exposed to harsh wash and abrasive conditions.

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A coating composition comprising:
(A) a resin having a hydroxyl number of at least 2;
(B) a pigment;
(C) a crosslinking agent comprising an isocyanate prepolymer; and
(D) a solvent.

2. The coating composition of claim 1, wherein the resin has a hydroxyl number of from 2 to 300.

3. The coating composition of claim 1, wherein the resin has a molecular weight of from 1,600 g/mol to 60,000 g/mol.

4. The coating composition of claim 1, wherein the resin is selected from the group consisting of a polyester resin, a phenoxy resin, an acrylic polyol resin, an alkyd resin, and a combination thereof.

5. The coating composition of claim 1, wherein the pigment is selected from the group consisting of silica, titanium dioxide, calcium carbonate, magnesium silicate, talc, aluminum hydroxide, and combinations thereof.

6. The coating composition of claim 1, wherein the pigment comprises
(i) a first pigment comprising a silica; and
(ii) a second pigment selected from the group consisting of titanium dioxide, calcium carbonate, magnesium silicate, talc, aluminum hydroxide, and combinations thereof.

7. The coating composition of claim 6, wherein the dry mass ratio of the second pigment to the first pigment is from 0.25 to 3.

8. The coating composition of claim 1, wherein the crosslinking agent has an NCO content of at least 2.5.

9. The coating composition of claim 1, wherein the solvent is selected from the group consisting of n-butyl acetate, methyl n-amyl ketone, xylene, cyclohexanone, N-methyl-2-pyrrolidone, and combinations thereof.

10. A method of forming the coating composition of claim 1 comprising:
(A) mixing the resin having a hydroxyl number of at least 2, the pigment, the solvent, and the dispersant to form a composition;
(B) mixing the crosslinking agent comprising the isocyanate prepolymer with the composition under reactive conditions to form the coating composition.

11. A coated label comprising:
(A) a polymeric substrate having a top surface and an opposing bottom surface;
(B) an adhesive layer in contact with the bottom surface of the polymeric substrate; and
(C) a coating layer in contact with the top surface of the polymeric substrate, the coating layer formed from a coating composition comprising
(i) a resin having a hydroxyl number of at least 2;
(ii) a pigment;
(iii) a crosslinking agent comprising an isocyanate prepolymer; and
(iv) a solvent.

12. The coated label of claim 11 further comprising
(D) a metal-detectable layer having a top surface and an opposing bottom surface,
wherein the top surface of the metal-detectable layer contacts the bottom surface of the polymeric substrate; and
the bottom surface of the metal detectable layer contacts the adhesive layer.

13. A method for forming a coated label comprising:
(A) mixing a resin having a hydroxyl number of at least 2, a pigment, a first solvent, and a dispersant to form a composition;
(B) mixing a crosslinking agent comprising an isocyanate prepolymer with the composition under reactive conditions to form a coating composition;
(C) applying the coating composition to a top surface of a polymeric substrate to form a coated substrate;
(D) drying the coated substrate to form a dried coated substrate;
(E) exposing the dried coated substrate to a mordant composition comprising a second solvent, a mordant, and a surfactant to form a mordant-treated coated substrate;
(F) drying the mordant-treated coated substrate to form a dried mordant-treated coated substrate;
(G) applying an adhesive layer to a bottom surface of the polymeric substrate of the dried mordant-treated coated substrate to form a coated label.

14. The method of claim 13, wherein the mordant is a metal salt.

15. The method of claim 13, wherein the mordant is anhydrous calcium chloride.

16. The method of claim 13, wherein the second solvent is water.

17. The method of claim 13, further comprising the step of
(H) inkjet printing an ink layer onto a top surface of the coated label to form a printed coated label.

18. The method of claim 13, wherein the printed coated label has at least one of
(i) a cyan color density of at least 0.75;
(ii) a magenta color density of at least 0.90;
(iii) a yellow color density of at least 0.90; and/or
(iv) a black color density of at least 0.83.

19. The method of claim 13, wherein the printed coated label has a dry time of 30 seconds or less.

20. The method of claim 13, wherein the printed coated label exhibits no visible change after harsh wash (1,000 psi; 70° C. water; distance of 12 inches; water flow of 4 gal/min; 30 second spray at horizontal angle to label top surface).
